(19) United States
(12) Patent Application Publication
(10) Pub. No.: US 2026/0292091 A1
(43) Pub. Date: Sep. 24, 2026

(54) Managing registration errors in digital printing

(71) Applicant: Landa Corporation Ltd., Rehovot (IL)

(72) Inventors: Yuri SHIRMAN, Rehovot (IL); Moshe SHKLAR, Ofra (IL); Tomer YANIR, Mazkeret Batya (IL); Avraham GUTTMAN, Yavne (IL)

(21) Appl. No.: 19/473,518

(22) PCT Filed: Apr. 8, 2024
(86) PCT No.: PCT/IB2024/053416

§ 371 Date: Oct. 8, 2025

Related U.S. Application Data
(60) Provisional application No. 63/459,754, filed on Apr. 17, 2023.
(60) Provisional application No. 63/515,349, filed on Jul. 25, 2023.

(51) Int. Cl. H04N 1/46; B41J 2/21

(52) U.S. Cl. CPC H04N 1/465; B41J 2/2132

(57) ABSTRACT

A method for selecting a region (27) of an image (42) for training a neural network to detect a color registration error, the method including receiving first and second ink images (23, 24) of first and second ink colors, respectively, which are intended to be applied to a substrate (50) for printing the image thereon. A first gradient image (47) is produced based on the first ink image, and a second gradient image (59) is produced based on the second ink image. For at least a given region (28): (i) a level of overlap, between first and second structures appearing in the region (27) in the first and second gradient images, respectively, is calculated, and (ii) the given region (28) is selected for the training in response to finding that the level of overlap in the given region (28) exceeds a predefined threshold.

### CROSS-REFERENCE TO RELATED APPLICATIONS

This application claims the benefit of U.S. Provisional Patent Application 63/459,754, filed Apr. 17, 2023, and U.S. Provisional Patent Application 63/515,349, filed Jul. 25, 2023, whose disclosures are incorporated herein by reference.

### FIELD OF THE INVENTION

The present invention relates generally to digital printing, and particularly to methods and systems for using neural networks for detecting and monitoring color-to-color registration errors in digital printing.

### BACKGROUND OF THE INVENTION

Various techniques for detecting and monitoring color-to-color registration errors in digital printing have been developed.

### SUMMARY OF THE INVENTION

An embodiment of the present invention that is described herein provides a method for selecting a region of an image for training a neural network to detect a color registration error, the method including receiving first and second ink images of first and second ink colors, respectively, which are intended to be applied to a substrate for printing the image thereon. A first gradient image is produced based on the first ink image, and a second gradient image is produced based on the second ink image. For at least a given region: (i) a level of overlap, between first and second structures appearing in the region in the first and second gradient images, respectively, is calculated, and (ii) the given region is selected for the training in response to finding that the level of overlap in the given region exceeds a predefined threshold.

In some embodiments, the first and second ink images are in a first color space, and the first and second gradient images are in a second color space, different from the first color space. In other embodiments, producing the first and second gradient images includes: (i) producing first and second images in the second color space by converting the first and second ink images, respectively, from the first color space to the second color space, and (ii) producing the first and second gradient images by applying one or more gradient filters to the first and second images, respectively. In yet other embodiments, the first color space includes at least cyan, magenta, yellow and black (CMYK) colors, and the second color space includes at least red, green and blue (RGB) colors, and the first ink image includes a cyan ink image.

In some embodiments, converting the first ink image includes converting first gray levels (GLs) of the first ink image to second GLs of the RGB colors. In other embodiments, producing the first and second gradient images includes: (i) applying the one or more gradient filters to the first image along a first direction and a second direction for producing a first pair of the first gradient image, and (ii) applying the one or more gradient filters to the second image along the first and second directions for producing a second pair of the second gradient image. In yet other embodiments, at least one of the gradient filters includes a sobel filter.

In some embodiments, the method includes producing (i) a first binary image based on the first gradient image, and (ii) a second binary image based on the second gradient image, and calculating the level of overlap includes calculating the level of overlap between the first and second structures appearing in the region in the first and second binary images, respectively. In other embodiments, each of the first and second binary images includes a predefined number of pixels, and calculating the level of overlap includes: (i) calculating a number of pixels that appear in both the first and second structures, and (ii) calculating the level of overlap by calculating a ratio between the calculated number of pixels and the predefined number of pixels. In yet other embodiments, the method includes determining, based on the level of overlap, a quality index to the given region for the training.

There is additionally provided, in accordance with an embodiment of the present invention, a system for selecting a region of an image for training a neural network to detect a color registration error, the system includes: (i) an interface, which is configured to receive first and second ink images of first and second ink colors, respectively, which are intended to be applied to a substrate for printing the image thereon, and (ii) a processor, which is configured to: (a) produce a first gradient image based on the first ink image, and a second gradient image based on the second ink image, and (b) for at least a given region: calculate a level of overlap between first and second structures appearing in the region in the first and second gradient images, respectively, and select the given region for the training in response to finding that the level of overlap in the given region exceeds a predefined threshold.

There is additionally provided, in accordance with an embodiment of the present invention, an apparatus for estimating a color-to-color registration error (C2C) in an image printed on a substrate using a printing system, the apparatus includes an interface and a processor. The interface is configured to receive, for at least a pair among multiple pairs of first and second colors formed in multiple regions of a digital image acquired from the image, respectively, a dataset including: (i) a first estimated C2C between the first and second colors, (ii) a confidence level of the first estimated C2C, and (iii) a location of the pair in the image. The processor is configured to: (a) estimate, based on at least the dataset, a distortion occurring in an intermediate transfer member (ITM) used in the printing system for transferring the image to the substrate in printing the image, (b) produce a second estimated C2C based on: (i) the dataset, and (ii) the estimated distortion, and (c) output the second estimated C2C.

In some embodiments, the interface is configured to receive an additional dataset indicative of an additional distortion occurring in the image, and the processor is configured to apply the additional distortion for producing the second estimated C2C. In other embodiments, the additional dataset includes measurements of C2C based on registration marks formed on the substrate. In yet other embodiments, the processor is configured to apply the additional distortion for estimating the distortion occurring in the ITM.

In some embodiments, the processor is configured to estimate the distortion occurring in the ITM by applying a linear model to at least the dataset in at least a region among the multiple regions. In other embodiments, the processor is configured to apply the linear model by applying a shift to a first position of the first color relative to a second position of the second color. In yet other embodiments, the processor is configured to apply the linear model by applying a scaling factor for altering a magnification in at least the region.

In some embodiments, the processor is configured to estimate the distortion occurring in the ITM by applying a non-linear model to at least the dataset in at least a region among the multiple regions. In other embodiments, the processor is configured to apply the non-linear model by applying an affine transformation along an axis of the image. In yet other embodiments, the axis is parallel to a direction of motion of the ITM.

In some embodiments, the processor is configured to apply the non-linear model by applying a projective transformation along a first axis and a second axis of the image. In other embodiments, the first axis is parallel to a direction of motion of the ITM and the second axis orthogonal to the direction of motion of the ITM.

There is further provided, in accordance with an embodiment of the present invention, a method for estimating a color-to-color registration error (C2C) in an image printed on a substrate using a printing system, the method including receiving, for at least a pair among multiple pairs of first and second colors formed in multiple regions of a digital image acquired from the image, respectively, a dataset including: (i) a first estimated C2C between the first and second colors, (ii) a confidence level of the first estimated C2C, and (iii) a location of the pair in the image. A distortion occurring in an intermediate transfer member (ITM) used in the printing system for transferring the image to the substrate in printing the image, is estimated based on at least the dataset. A second estimated C2C is produced based on: (i) the dataset, and (ii) the estimated distortion, and the second estimated C2C is outputted.

The present invention will be more fully understood from the following detailed description of the embodiments thereof, taken together with the drawings in which:

### BRIEF DESCRIPTION OF THE DRAWINGS

FIG. 1 is a schematic side view of a digital printing system, in accordance with an embodiment of the present invention;

FIG. 2 is a schematic pictorial illustration of smoothing and resizing applied to a region of an ink image, in accordance with an embodiment of the present invention;

FIG. 3 is a schematic pictorial illustration of cyan droplets applied to a region, shown in gray levels of red, green, and blue images of the same region, in accordance with an embodiment of the present invention;

FIG. 4 is a schematic pictorial illustration of gray level images converted to gradient images, in accordance with an embodiment of the present invention;

FIG. 5 is a schematic pictorial illustration of a red-green-blue (RGB) gradient image produced by combining gradient images of red, green and blue, in accordance with an embodiment of the present invention;

FIG. 6 is a schematic pictorial illustration of overlayed binary images of a region, produced by overlaying pairs of images and identifying joint patterns in the pairs of images, in accordance with an embodiment of the present invention;

FIG. 7 is a schematic pictorial illustration of a criterion for selecting binary images, which are suitable for training the neural network to detect C2C registration in digital images acquired from images printed using the digital printing system of FIG. 1, in accordance with an embodiment of the present invention;

FIG. 8 is a flow chart that schematically illustrates a method for selecting a region of an image for training a neural network to detect color registration errors between two colors of the image, in accordance with an embodiment of the present invention;

FIG. 9 is a schematic top view of color-to-color registration errors (C2C) detected by a neural network in an image printed by the system of FIG. 1, in accordance with an embodiment of the present invention;

FIGS. 10A, 10B and 10C are schematic illustrations of linear models for estimating a distortion occurring in a blanket of the system of FIG. 1, in accordance with embodiments of the present invention;

FIGS. 11 and 12 are schematic illustrations of non-linear models for estimating a distortion occurring in a blanket of the system of FIG. 1, in accordance with an embodiment of the present invention; and

FIG. 13 is a flow chart that schematically illustrates a method for improving the estimated C2C in the image of FIG. 9, in accordance with an embodiment of the present invention.

### DETAILED DESCRIPTION OF EMBODIMENTS

### Overview

In some cases, printed images may have some geometrical distortions, such as color-to-color (C2C) registration errors. For example, in a digital printing system, the image is formed by applying to a substrate multiple droplets having different colors, and some variations in the printing process may result in the C2C registration error.

Moreover, the digital printing system may comprise an image forming station for jetting multiple colors of printing fluids onto an intermediate transfer member (ITM) for producing the image thereon, and subsequently, the image is transferred to the substrate, also referred to herein as a target substrate, such as a sheet or a continuous web. In some cases, C2C may occur while forming the image on the target substrate.

Embodiments of the present invention that are described hereinbelow provide techniques for (i) selecting a region of an image for training a neural network to detect C2C registration errors in images printed using a digital printing system, and (ii) improving estimation of color-to-color registration errors (C2C), which is detected between pair of colors of printing fluids in a printed image, using a neural network.

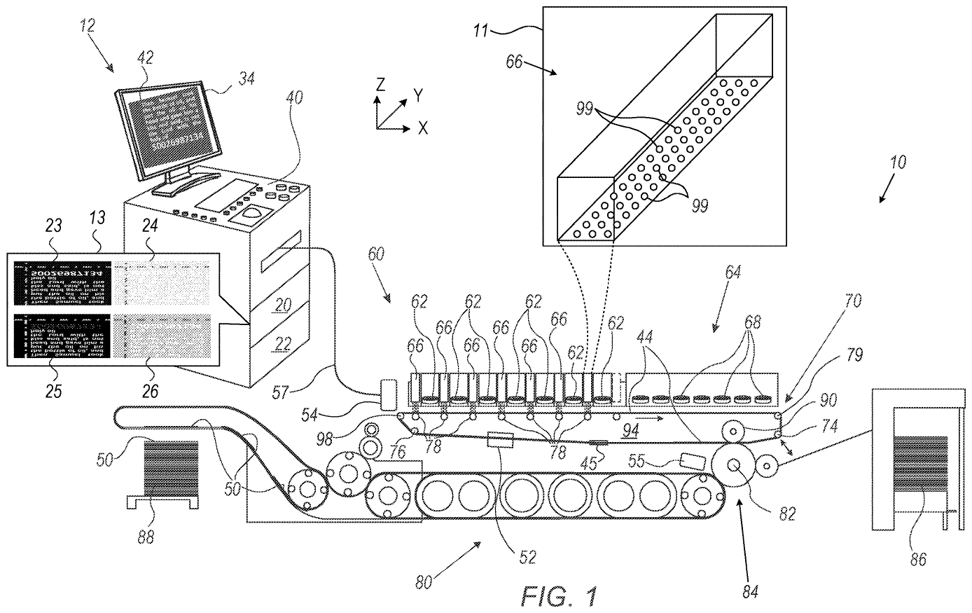

In some embodiments, a digital printing system comprises an intermediate transfer member (ITM), also referred to herein as a blanket, which is flexible, and the structure and functionality are described in FIG. 1 below. The digital printing system further comprises a printing assembly having: (i) an image forming station configured to apply droplets of printing fluids (e.g., jetting ink droplets having different colors) to a surface of the blanket for producing an image thereon, (ii) an impression station, configured to transfer the image from the blanket to a target substrate (e.g., a sheet), and (iii) a blanket module configured to move the blanket for (a) producing the image by receiving the ink droplets from the image forming station, and (b) transferring the image to the sheet.

In some embodiments, the digital printing system further comprises (i) an image quality control station, configured to acquire a digital image of the image printed on the sheet, and (ii) a processor, which is configured to: (a) control the printing assembly, the image quality control station, and other components and stations of the digital printing system, and (b) analyze digital images acquired from the printed images, e.g., using the image quality control station, and (iii) an interface configured to exchange signals between the processor and other entities, of the system and external to the system.

In some embodiments, before the printing process, the processor is configured to receive, e.g., via the interface, a digital color image intended to be printed by the system. During a screening process that may be carried out by the processor or by any other processing unit, the digital color image is converted into multiple color images, also referred to herein as screening images (SIs) of the colors of ink intended to be applied to the blanket for producing the image thereon. In the present example, the image is formed using four colors of ink: cyan (C), magenta (M), yellow (Y) and black (K), and therefore, after the screening process, the processor receives C, M, Y and K images. In other examples, the image may be formed using any other suitable number on ink colors, e.g., seven colors.

In some embodiments, the digital printing system further comprises a neural network (NN), configured to estimate C2C between pairs of colors in multiple regions (also referred to herein as patches) of the digital image. Example implementations of applying neural networks for estimating registration errors in printed images are described, for example, in U.S. Pat. No. 11,630,618, and in U.S. Provisional Patent Application No. 63/459,754, whose disclosures are all incorporated herein by reference.

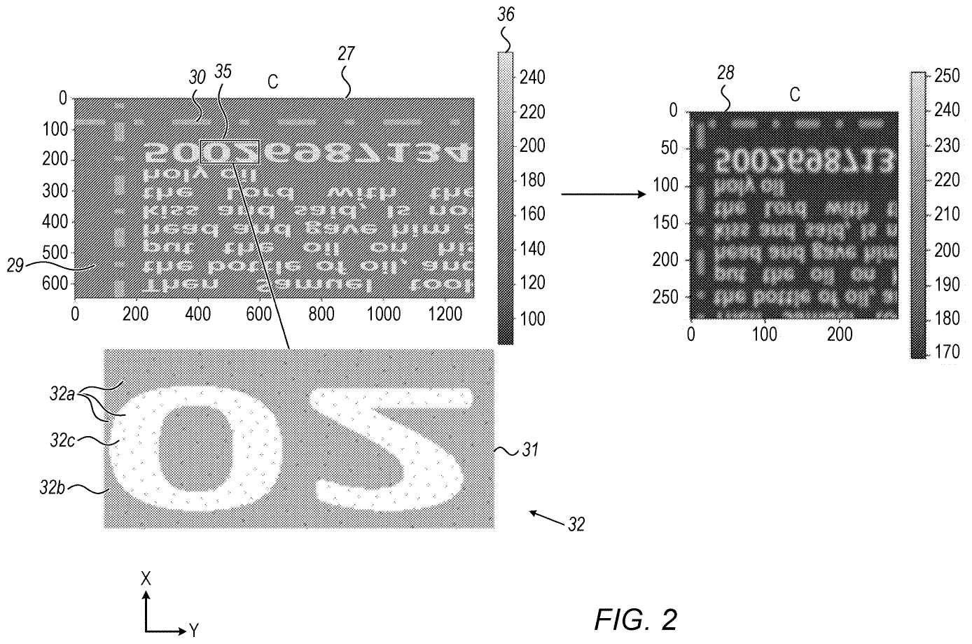

In some embodiments, the processor is configured to select one or more regions (also referred to herein as patches) in each of the SIs. These regions are candidate regions for training the NN, such as but not limited to a convolutional NN (CNN), to detect C2C registration errors between each pair of colors among the CMYK colors of the respective four SIs. In the present example, each pixel of the SIs is formed by applying between zero and two droplets of ink of at least one of the CMYK colors. Therefore, the morphology of the SI images is digital and relatively rough rather than being continuous and smooth, as shown and described in detail in an inset of FIG. 2 below.

In some embodiments, for each of the selected regions, the processor is configured to apply to the image one or more smoothing filters, and to resize the image to match with the size of the digital image acquired by the image quality control station as described above. The image smoothing and resizing are described in detail in FIG. 2 below.

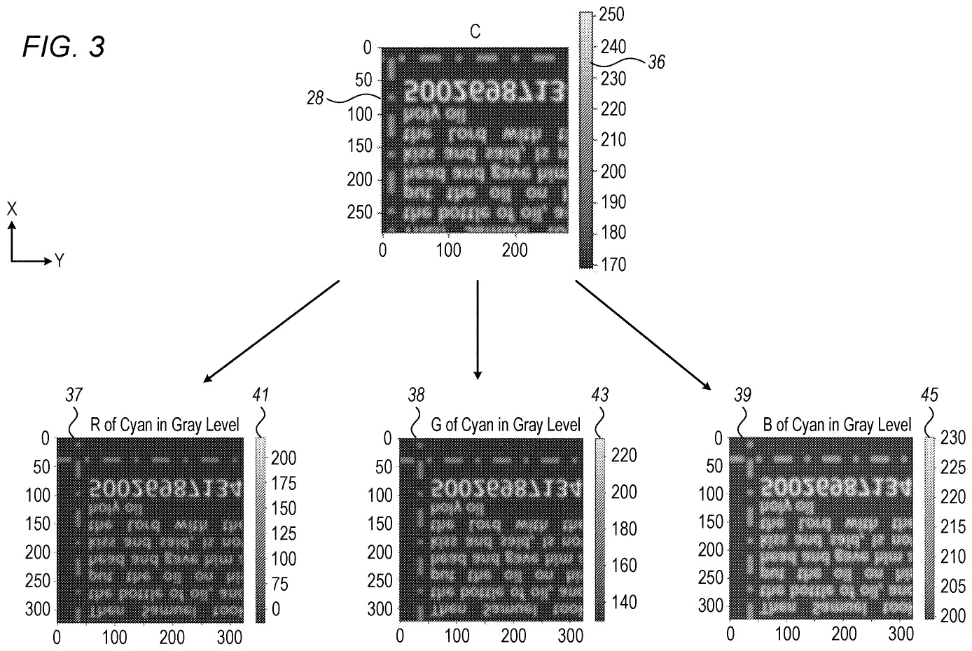

In some embodiments, for each of the selected regions, the processor is configured to convert the gray level of each of the C, M, Y, K images to gray levels of red, green and blue images, as shown and described in detail in FIG. 3 below.

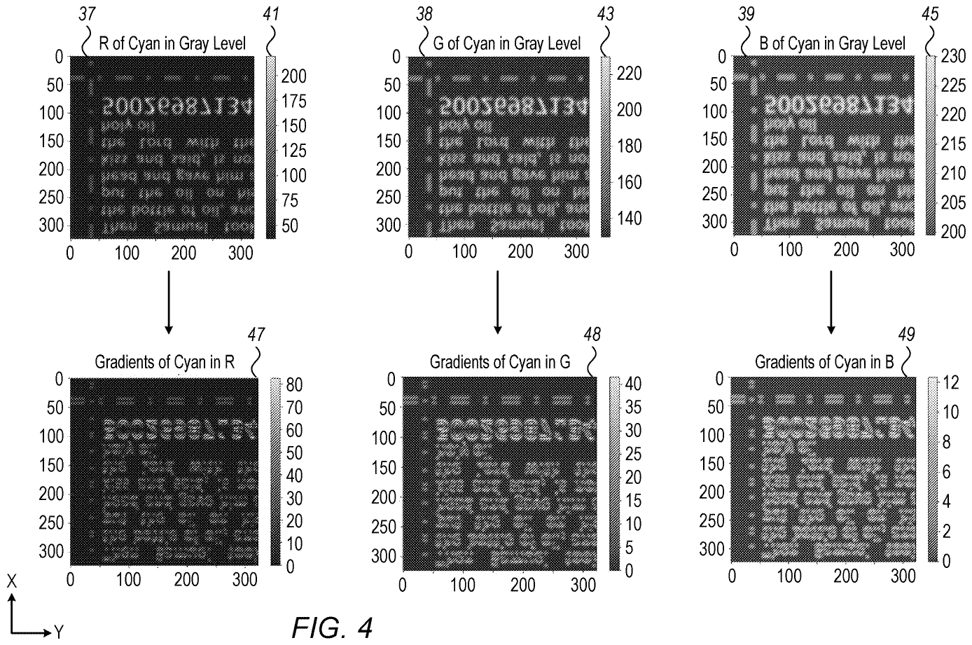

In some embodiments, for each of the images in the selected regions, the processor is configured to apply one or more gradient filters for producing, for each of the red, green and blue images, (i) a first gradient image when applying the gradient filter(s) along the X-axis, and (ii) a second gradient image when applying the gradient filter(s) along the Y-axis. In such embodiments, the processor produces, for each of the C, M, Y, and K images, two sets of red, green, and blue gradient images, as described in detail in FIG. 4 below.

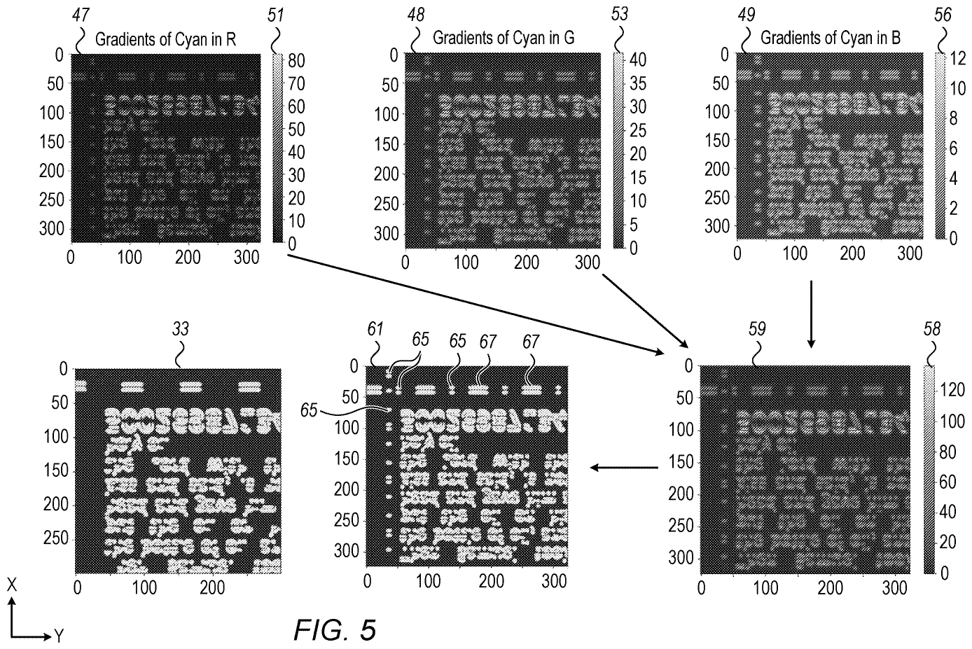

In some embodiments, based on the two sets of red, green, and blue gradient images along the X- and Y-axes, the processor is configured to produce, for each of the C, M, Y, and K images of each region, first and second red-green-blue (RGB) gradient images, respectively. Moreover, the processor is configured to apply additional filters for converting the first and second RGB gradient images to binary images, as shown and described in detail in FIG. 5 below.

In the present example, the first and second binary images formed by applying the filters (including the gradient filters along the X- and Y-axes, respectively) to a selected region in the cyan SI, are referred to herein as Cx and Cy images, respectively. Similarly, the processor is configured to produce for each region, (i) Mx and My images based on the magenta SI, (ii) Yx and Yy images based on the yellow SI, and (iii) Kx and Ky images based on the black SI.

In some embodiments, for each of the regions and first and second RGB gradient images of each SI, the processor is configured to calculate a level of overlap between first and second structures appearing in RGB gradient images of first and second colors among the C, M, Y and K SIs, respectively. For example, for each region selected in the cyan and magenta SIs, the processor is configured to calculate the level of overlap between (i) the structures appearing in the Cx and Mx images, and (ii) the structures appearing in the Cy and My images.

In some embodiments, the processor is configured to compare between the calculated level of overlap and a predefined threshold. Moreover, for the training of the NN, the processor is configured to select a given region whose level of overlap exceeds the predefined threshold. For example, in case the level of overlap between the structures appearing in the Cx and Mx images of the given region, exceeds the predefined threshold, the given region will be selected by the processor for training the NN to detect C2C registration errors between the cyan and magenta images along the X-axis.

In some embodiments, the digital printing system comprises an apparatus having the interface and the processor. The interface is configured to receive (e.g., from the neural network or from any other source) a dataset for multiple pairs of the colors formed in multiple regions of the digital image described above. In the present example, the dataset comprises: (i) an estimated C2C between each pair of the colors at predefined patterns in the regions analyzed by the NN, (ii) a confidence level of each of the estimated C2Cs, and (iii) a location of each of the pairs in the image.

In some embodiments, the digital image acquired by the image quality control system comprises marks printed at the edge of the sheet. The marks are indicative of registration errors occurring during the printing process. More specifically, the marks have different colors, e.g., cyan, magenta, yellow and black, arranged in a nominal arrangement, so that any deviation from the nominal arrangement is indicative of C2C between respective pairs of colors.

In some embodiments, the processor of the aforementioned apparatus is configured to estimate, based on at least the dataset received from the NN, and in some cases also based on the marks at the edge of the sheet, a distortion occurring in the blanket of the printing system. It is noted that the C2C may occur, inter alia, due to (i) a mismatch between the movement speed of the blanket and the timing of jetting the different colors of ink, and (ii) a distortion in the flexible blanket.

In some embodiments, the processor is configured to apply to the datasets described above, a linear model or a non-linear model, for estimating the distortion in the blanket.

In some embodiments, the processor is configured to combine: (i) the C2C based on the dataset received from the NN, and (ii) an additional distortion in the image, based on an additional dataset (e.g., received from the image quality control station). For example, the additional distortion in the image may comprise the blanket distortion, so that the processor may combine the datasets described above for producing an improved estimation of the C2C compared to that received from the NN.

In some embodiments, the processor and/or the interface are configured to output the improved estimation of C2C, for example, by overlaying an indication of the improved estimated C2C on the respective patches of the digital image. In other words, the accuracy of the estimated C2C received from the NN is improved by applying post processing that includes the blanket distortion and additional dataset based on the marks that are typically, but not necessarily, located at one or more edges of the sheet.

In some cases, based on the color scheme of the printed image, one or more (and sometimes all) of the patches may not have all the colors of ink. In some embodiments, the processor is configured to apply weighting factors to the data received from (i) the NN-dataset, and (ii) the additional dataset, e.g., received from the image quality control station. For example, (a) in case all the colors appear in the regions (patches) that are analyzed by the NN, and these patches are distributed approximately evenly along and across the printed image, then the processor may apply a larger weighting factor to the NN-based dataset compared to that of the additional dataset, and (b) in case the patches exclude a given color, then for C2C estimation between (i) the given color, and (ii) one or more of the other colors of the image, the processor may use only the additional dataset.

In some cases, the dataset received from the NN may comprise C2C estimated between some pairs of the colors, but not between other pairs of the colors. For example, an example patch may have cyan, yellow, and magenta colors, but the dataset may comprise: (i) a first C2C estimation between the cyan and yellow, and (ii) a second C2C estimation between the cyan and the magenta. However, the dataset may not have any estimated C2C between the yellow and magenta colors. In some embodiments, based on the aforementioned first and second C2C estimations, the processor is configured to estimate the C2C between the yellow and magenta colors.

All the above example implementations, as well as additional implementations, are described in detail in FIGS. 9-13 below.

The disclosed techniques improve the quality of images printed by a digital printing system, and further improve the productivity of such systems by (i) enabling fast detection and fixing of distortions, such as C2C registration errors, which may occur during a printing process in a digital printing system, and (ii) improving the accuracy of C2C received from neural networks, and thereby, enabling a reduced level of C2C between the pairs of colors in the image. Moreover, the disclosed techniques may be applicable to other sorts of printing systems applying multiple ink images to a substrate for producing an image thereon.

### System Description

FIG. 1 is a schematic side view of a digital printing system 10, in accordance with an embodiment of the present invention. In some embodiments, system 10 comprises a rolling flexible blanket 44 that cycles through an image forming station 60, a drying station 64, an impression station 84 and a blanket treatment station 52. In the context of the present invention and in the claims, the terms “blanket” and “intermediate transfer member (ITM)” are used interchangeably and refer to a flexible member comprising one or more layers used as an intermediate member, which is formed in an endless loop configured to receive an ink image, e.g., from image forming station 60, and to transfer the ink image to a target substrate, as will be described in detail below.

In an operative mode, image forming station 60 is configured to form a mirror ink image, also referred to herein as “an ink image” (not shown) or as an “image” for brevity, of a digital image 42 on an upper run of a surface of blanket 44. Subsequently the ink image is transferred to a target substrate, (e.g., a paper, a folding carton, a multilayered polymer, or any suitable flexible package in a form of sheets or continuous web) located under a lower run of blanket 44.

In the context of the present invention, the term “run” refers to a length or segment of blanket 44 between any two given rollers over which blanket 44 is guided.

In some embodiments, during installation, blanket 44 may be adhered edge to edge, using a seam section also referred to herein as a seam 45, so as to form a continuous blanket loop, also referred to herein as a closed loop. An example of a method and a system for the installation of seam 45 is described in detail in U.S. Patent Application Publication 2020/0171813, whose disclosure is incorporated herein by reference.

In some embodiments, image forming station 60 typically comprises multiple print bars 66, each print bar 66 mounted on a frame (not shown) positioned at a fixed height (i.e., distance along a Z-axis of an XYZ coordinate system of system 10) above the surface of the upper run of blanket 44.

Reference is now made to an inset 11, showing print bar 66. In some embodiments, each print bar 66 is assigned to jet a predefined color of a printing fluid (e.g., as an aqueous ink of a selected color). For example, a system for printing an image using cyan (C), magenta (M) yellow (Y) and Black (K) colors, may comprise four active print bars 66, one for each color. In the present example, image forming station 60 comprises seven print bars 66 for printing images having seven colors, as will be described below.

In some embodiments, each print bar 66 has a width, along the Y-axis, as wide as the printing area of blanket 44 and an array of individually controllable print nozzles 99 arranged along the X- and Y-axes of the print heads of print bar 66. Each nozzle 99 is configured to apply (e.g., by jetting and/or otherwise directing) the printing fluid (e.g., ink) toward a predefined position on blanket 44 that is moved by system 10.

Reference is now made back to the general view of FIG. 1. In some embodiments, each print bar 66 comprises a strip of print heads (shown in FIG. 2 below) extended along the Y-axis of the respective print bar 66.

In some embodiments, image forming station 60 may comprise any suitable number of print bars 66, also referred to herein as bars 66, for brevity. Each bar 66 may contain a printing fluid, such as an aqueous ink of a different color. The ink typically has visible colors, such as but not limited to cyan, magenta, red, green, blue, yellow, black, and white.

In some embodiments, the print heads are configured to jet ink droplets of the different colors onto the surface of blanket 44 so as to form the ink image (not shown) on the surface of blanket 44. In the present example, blanket 44 is moved along an X-axis of the XYZ coordinate system of system 10, and the ink droplets are directed by nozzles 99 of the print heads, typically parallel to a Z-axis of the coordinate system.

In some embodiments, different print bars 66 are spaced from one another along the movement axis, also referred to herein as a moving direction 94 of blanket 44, a direction of motion of blanket 44, or a printing direction of system 10. In the present example, the moving direction of blanket 44 is parallel to the X-axis, and each print bar 66 is extended along the Y-axis of the XYZ coordinates of system 10. The Y-axis is also referred to herein as the cross-printing direction, which is orthogonal to the direction of motion of blanket 44. In this configuration, high accuracy of: (i) spacing between bars 66 along the X-axis (and other calibration parameters described below), (ii) synchronization between (a) jetting of the ink droplets from each bar 66, and (b) movement of blanket 44, are essential for enabling correct placement of the image pattern. It is noted that every droplet has an intended position on a target substrate (e.g., in the aforementioned XYZ coordinate system). In the context of the present disclosure, the term addressability refers to the ability of system 10 to place a given droplet on the target substrate, at the intended position thereof.

Moreover, in the context of the present disclosure and in the claims, the terms “inter-color pattern placement,” “pattern placement accuracy,” “color-to-color registration,” “C2C registration,” “C2C,” and “color registration” are used interchangeably and refer to any placement accuracy of two or more colors relative to one another. More specifically, the term C2C refers to a color-to-color registration error between two selected colors of the printed image.

In some embodiments, system 10 comprises heaters 62, such as hot gas or air blowers and/or infrared-based heaters with gas or air blowers for flowing gas or air at any suitable temperature. Heaters 62 are positioned in between print bars 66, and are configured to partially dry the ink droplets deposited on the surface of blanket 44. This air flow between the print bars may assist, for example, (i) in reducing condensation at the surface of the print heads and/or in handling satellites (e.g., residues or small droplets distributed around the main ink droplet), and/or (ii) in preventing clogging of the orifices of the inkjet nozzles of the print heads, and/or (iii) in preventing the droplets of different color inks on blanket 44 from undesirably merging into one another.

In some embodiments, system 10 comprises drying station 64, configured to direct infrared radiation and cooling air (or another gas), and/or to blow hot air (or another gas) onto the surface of blanket 44. In some embodiments, drying station 64 may comprise infrared-based illumination assemblies (not shown) and/or air blowers 68 or any other suitable sort of drying apparatus.

In some embodiments, in drying station 64, the ink image formed on blanket 44 is exposed to radiation and/or to hot air in order to dry the ink more thoroughly, evaporating most or all of the liquid carrier and leaving behind only a layer of resin and coloring agent which is heated to the point of being rendered a tacky ink film.

In some embodiments, system 10 comprises a blanket module 70, also referred to herein as an ITM module, comprising a rolling flexible ITM, such as a flexible blanket 44. In some embodiments, blanket module 70 comprises one or more rollers 78, wherein at least one of rollers 78 comprises a motion encoder (not shown), which is configured to record the position of blanket 44, so as to control the position of a section of blanket 44 relative to a respective print bar 66. In some embodiments, one or more motion encoders may be integrated with additional rollers and other moving components of system 10.

In some embodiments, the aforementioned motion encoders typically comprise at least one rotary encoder configured to produce rotary-based position signals indicative of an angular displacement of the respective roller. Note that in the context of the present invention and in the claims, the terms “indicative of” and “indication” are used interchangeably.

Additionally, or alternatively, blanket 44 may comprise an integrated encoder (not shown) for controlling the operation of various modules of system 10. One implementation of the integrated motion encoder is described in detail, for example, in PCT International Publications WO 2021/044303, and WO 2020/003088, whose disclosures are all incorporated herein by reference.

In some embodiments, blanket 44 is guided in blanket module 70 over rollers 76, 78 and other rollers described herein, and over a powered tensioning roller, also referred to herein as a dancer assembly 74. Dancer assembly 74 is configured to control the length of slack in blanket 44 and its movement is schematically represented in FIG. 1 by a double-sided arrow. Furthermore, any stretching of blanket 44 with aging would not affect the ink image placement performance of system 10 and would merely require the taking up of more slack by tensioning dancer assembly 74.

In some embodiments, dancer assembly 74 may be motorized. The configuration and operation of rollers 76 and 78 are described in further detail, for example, in U.S. Patent Application Publication 2017/0008272 and in the above-mentioned PCT International Publication WO 2013/132424, whose disclosures are all incorporated herein by reference.

In some embodiments, system 10 comprises a blanket tension drive roller (BTD) 98 and a blanket control drive roller (BCD) 79, which are powered by respective first and second motors, typically electric motors (not shown) and are configured to rotate about their own first and second axes, respectively.

In some embodiments, system 10 may comprise one or more tension sensors (not shown) disposed at one or more positions along blanket 44. The tension sensors may be integrated in blanket 44 or may comprise sensors external to blanket 44 using any other suitable technique to acquire signals indicative of the mechanical tension applied to blanket 44. In some embodiments, processor 20 and optionally additional controllers of system 10, are configured to receive the signals produced by the tension sensors, so as to monitor the tension applied to blanket 44 and to control the operation of dancer assembly 74.

In impression station 84, blanket 44 passes between an impression cylinder 82 and a pressure cylinder 90, which is configured to carry a compressible blanket. In some embodiments, a motion encoder (not shown) is integrated with at least one of impression cylinder 82 and pressure cylinder 90.

In some embodiments, system 10 comprises a control console 12, which is configured to control multiple modules of system 10, such as (i) blanket module 70, (ii) image forming station 60 located above blanket module 70 (along the Z-axis), and (iii) a substrate transport module 80, which is located below blanket module 70 (along the Z-axis) and comprises one or more impression stations as will be described below.

In some embodiments, console 12 comprises a processor 20, in the context of the present disclosure and in the claims, the term “processor” refers to one or more of the following devices: (i) any suitable type of a central processing unit (CPU) such as but not limited to a general-purpose processor, (ii) a graphical processing unit (GPU), (iii) a tensor processing unit (TPU), (iv) a digital signal processor (DSP), and (v) any other suitable type of an application-specific integrated circuit (ASIC). At least one of, and typically all the above types of processing units may have suitable front end and interface circuits configured for interfacing and exchanging signals with (a) several modules and stations of system 10, and (b) entities external to system 10. Moreover, at least the GPU and the TPU (and optionally more of the aforementioned processing units) are configured, inter alia, to accelerate deep learning and/or machine learning workloads in one or more neural networks implemented in software and/or hardware in any suitable device of console 12.

In some embodiments, processor 20 is configured to interface with controllers of dancer assembly 74 and with a controller 54, via a cable 57, and for receiving signals therefrom.

Additionally, or alternatively, console 12 comprises an interface 22, which is configured to exchange data between processor 20 and other entities of system 10 and/or external to system 10. In some embodiments, processor 20 may receive signals directly as written in some of the embodiments described above. In other embodiments, interface 22 may receive at least some of the signals, and transfer the signals to and from processor 20, e.g., via the aforementioned interface circuits of processor 20.

In some embodiments, controller 54, which is schematically shown as a single device, may comprise one or more electronic modules mounted on system 10 at predefined locations. At least one of the electronic modules of controller 54 may comprise an electronic device, such as control circuitry or a processor (not shown), which is configured to control various modules and stations of system 10. In some embodiments, processor 20 and the control circuitry may be programmed in software to carry out the functions that are used by the printing system, and store data for the software in a memory (not shown). The software may be downloaded to processor 20 and to the control circuitry in electronic form, over a network, for example, or it may be provided on non-transitory tangible media, such as optical, magnetic, or electronic memory media.

In some embodiments, console 12 comprises a display device, referred to herein as a display 34, which is configured to display data and images received from processor 20, or inputs inserted by a user (not shown) using input devices 40. In some embodiments, console 12 may have any other suitable configuration, for example, an alternative configuration of console 12 and display 34 is described in detail in U.S. Pat. No. 9,229,664, whose disclosure is incorporated herein by reference.

In some embodiments, processor 20 is configured to display on display 34, digital image 42 comprising one or more segments (not shown) of image 42 and/or various types of test patterns that may be stored in the aforementioned memory or in any other suitable device of system 10.

Reference is now made to an inset 13. In some embodiments, digital image 42 is produced using a first color space, in the present example the first color space comprises at least red, green, and blue (RGB) colors. In some embodiments, processor 20 is configured to produce, based on image 24, a plurality of ink images, in the present example, ink images 23, 24, 25 and 26, in a second color space, different from the first color space. Processor 20 is configured to produce ink images 23, 24, 25 and 26 by applying raster image processing (RIP), also referred to herein as performing a screening process, for converting the RGB colors of image 42 to the aforementioned C, M, Y and K colors of the second color space.

In some embodiments, four print bars 66 are assigned for jetting ink droplets of C, M, Y and K, respectively, and processor 20 is configured to control the four print bars 66 of image forming station 60, to apply the C, M, Y and K ink droplets to blanket 44 for producing the ink image corresponding to digital image 42.

Reference is now made back to the general view of FIG. 1. In some embodiments, blanket treatment station 52, also referred to herein as a cooling station, is configured to treat the blanket by, for example, cooling it and/or applying a treatment fluid to the outer surface of blanket 44, and/or cleaning the outer surface of blanket 44. At blanket treatment station 52, the temperature of blanket 44 can be reduced to a desired temperature-level before blanket 44 enters into image forming station 60. The treatment may be carried out by passing blanket 44 over one or more rollers or blades configured for applying cooling and/or cleaning and/or treatment fluid to the outer surface of the blanket.

In some embodiments, blanket treatment station 52 may further comprise one or more bars (not shown) positioned adjacent to print bars 66, so that the treatment fluid may, additionally or alternatively, be applied to blanket 44 by jetting.

In some embodiments, processor 20 is configured to receive, e.g., from temperature sensors (not shown), signals indicative of the surface temperature of blanket 44, so as to monitor the temperature of blanket 44 and to control the operation of blanket treatment station 52. Examples of such treatment stations are described, for example, in PCT International Publications WO 2013/132424 and WO 2017/208152, whose disclosures are all incorporated herein by reference.

In the example of FIG. 1, station 52 is mounted between impression station 84 and image forming station 60, yet station 52 may be mounted adjacent to blanket 44 at any other or additional one or more suitable locations between impression station 84 and image forming station 60. As described above, station 52 may, additionally or alternatively, be mounted on a bar adjacent to image forming station 60.

In the example of FIG. 1, impression cylinder 82 and pressure cylinder 90 impress the ink image onto the target flexible substrate, such as an individual sheet 50, conveyed by substrate transport module 80 from an input stack 86 to an output stack 88 via impression station 84. In the present example, a rotary encoder (not shown) is integrated with impression cylinder 82.

In some embodiments, the lower run of blanket 44 selectively interacts at impression station 84 with impression cylinder 82 to impress the image pattern onto the target flexible substrate compressed between blanket 44 and impression cylinder 82 by the action of pressure of pressure cylinder 90. In the case of a simplex printer (i.e., printing on one side of sheet 50) shown in FIG. 1, only one impression station 84 is needed.

In other embodiments, module 80 may comprise two or more impression cylinders (not shown) so as to permit one or more duplex printing. The configuration of two impression cylinders also enables conducting single sided prints at twice the speed of printing double sided prints. In addition, mixed lots of single- and double-sided prints can also be printed. In alternative embodiments, a different configuration of module 80 may be used for printing on a continuous web substrate. Detailed descriptions and various configurations of duplex printing systems and of systems for printing on continuous web substrates are provided, for example, in U.S. Pat. Nos. 9,914,316 and 9,186,884, in PCT International Publication WO 2013/132424, in U.S. Patent Application Publication 2015/0054865, and in U.S. Provisional Patent Application 62/596,926, whose disclosures are all incorporated herein by reference.

In some embodiments, the aforementioned target substrate may comprise sheets 50 or continuous web substrate (not shown) that are carried by module 80 (or any other suitable type of module) from input stack 86 and pass through the nip (not shown) located between impression cylinder 82 and pressure cylinder 90. Within the nip, the surface of blanket 44 carrying the ink image is pressed firmly, e.g., by the compressible blanket of pressure cylinder 90, against sheet 50 (or against another suitable substrate) so that the ink image is impressed onto the surface of sheet 50 and separated neatly from the surface of blanket 44. Subsequently, sheet 50 is transported to output stack 88.

In the example of FIG. 1, rollers 78 are positioned at the upper run of blanket 44 and are configured to maintain blanket 44 taut when passing adjacent to image forming station 60. Furthermore, it is particularly important to control the speed of blanket 44 below image forming station 60 so as to obtain accurate jetting and deposition of the ink droplets to form an image, by image forming station 60, on the surface of blanket 44.

In some embodiments, impression cylinder 82 is periodically engaged with and disengaged from blanket 44, so as to transfer the ink images from moving blanket 44 to the target substrate passing between blanket 44 and impression cylinder 82. In some embodiments, system 10 is configured to apply torque to blanket 44 using the aforementioned rollers and dancer assemblies, so as to maintain the upper run taut and to substantially isolate the upper run of blanket 44 from being affected by mechanical vibrations occurring in the lower run.

In some embodiments, system 10 comprises an image quality control station 55, also referred to herein as an automatic quality management (AQM) system, which serves as a closed loop inspection system integrated in system 10. In some embodiments, image quality control station 55 may be positioned adjacent to impression cylinder 82, as shown in FIG. 1, or at any other suitable location in system 10.

In some embodiments, image quality control station 55 comprises a camera (not shown), which is configured to acquire one or more digital images (DIs) of the aforementioned ink image printed on sheet 50, or on any other suitable type of target substrate. In some embodiments, the camera may comprise any suitable image sensor, such as a Contact Image Sensor (CIS) or a Complementary metal oxide semiconductor (CMOS) image sensor, and a scanner comprising a slit having a width of about one meter or any other suitable width.

In the context of the present disclosure and in the claims, the terms “about” or “approximately” for any numerical values or ranges indicate a suitable dimensional tolerance that allows the part or collection of components to function for its intended purpose as described herein.

In some embodiments, the digital images acquired by station 55 are transmitted to a processor, such as processor 20 or any other processor of station 55, which is configured to assess the quality of the respective printed images. Based on the assessment and signals received from controller 54, processor 20 is configured to control the operation of the modules and stations of system 10. In the context of the present invention and in the claims, the term “processor” refers to any suitable processing unit, such as processor 20 or any other processor or controller connected to or integrated with station 55, which is configured to process signals received from the camera and/or the spectrophotometer of station 55. Note that the signal processing operations, control-related instructions, and other computational operations described herein may be carried out by a single processor, or shared between multiple processors of one or more respective computers.

In some embodiments, station 55 is configured to inspect the quality of the printed images and test pattern so as to monitor various attributes, such as but not limited to full image registration with sheet 50, also referred to herein as image-to-substrate registration error, color-to-color (C2C) registration error (also referred to herein as color registration error), printed geometry, image uniformity, profile and linearity of colors, and functionality of the print nozzles. In some embodiments, processor 20 is configured to automatically detect geometrical distortions or other errors in one or more of the aforementioned attributes.

In some embodiments, processor 20 is configured to analyze the detected distortion in order to apply a corrective action to the malfunctioning module, and/or to feed instructions to another module or station of system 10, so as to compensate for the detected distortion.

In some embodiments, system 10 may print testing patterns (not shown) or other suitable features, for example at the bevels or margins of sheet 50. By acquiring images of the testing patterns, station 55 is configured to measure various types of distortions, such as C2C registration, image-to-substrate registration, different width between colors referred to herein as “bar to bar width delta” or as “color to color width difference”, various types of local distortions, and front-to-back registration errors (in duplex printing). In some embodiments, processor 20 is configured to: (i) sort out, e.g., to a rejection tray (not shown), sheets 50 having a distortion above a first predefined set of thresholds, (ii) initiate corrective actions for sheets 50 having a distortion above a second, lower, predefined set of threshold, and (iii) output sheets 50 having minor distortions, e.g., below the second set of thresholds, to output stack 88.

In some embodiments, processor 20 is configured to detect, based on signals received from the spectrophotometer of station 55, deviations in the profile and linearity of the printed colors.

In some embodiments, the processor of station 55 is configured to decide whether to stop the operation of system 10, for example, in case the density of distortions is above a specified threshold. The processor of station 55 is further configured to initiate a corrective action in one or more of the modules and stations of system 10, as described above. In some embodiments, the corrective action may be carried out on-the-fly (while system 10 continues the printing process), or offline, by stopping the printing operation and fixing the problem in respective modules and/or stations of system 10. In other embodiments, any other processor or controller of system 10 (e.g., processor 20 or controller 54) is configured to start a corrective action or to stop the operation of system 10 in case the density of distortions is above a specified threshold.

Additionally, or alternatively, processor 20 is configured to receive, e.g., from station 55, signals indicative of additional types of distortions and problems in the printing process of system 10. Based on these signals, processor 20 is configured to automatically estimate the level of pattern placement accuracy and additional types of distortions and/or defects not mentioned above. In other embodiments, any other suitable method for examining the pattern printed on sheets 50 (or on any other substrate described above) can also be used, for example, using an external (e.g., offline) inspection system, or any type of measurements jig and/or scanner. In these embodiments, based on information received from the external inspection system, processor 20 is configured to initiate any suitable corrective action and/or to stop the operation of system 10.

The configuration of system 10 is simplified and provided purely by way of example for the sake of clarifying the present invention. The components, modules and stations described in printing system 10 hereinabove and additional components and configurations are described in detail, for example, in U.S. Pat. Nos. 9,327,496 and 9,186,884, in PCT International Publications WO 2013/132438, WO 2013/132424 and WO 2017/208152, and in U.S. Patent Application Publications 2015/0118503 and 2017/0008272, whose disclosures are all incorporated herein by reference.

The particular configuration of system 10 is shown by way of example, in order to illustrate certain problems that are addressed by embodiments of the present invention and to demonstrate the application of these embodiments in enhancing the performance of such systems. Embodiments of the present invention, however, are by no means limited to this specific sort of example system, and the principles described herein may similarly be applied to any other sorts of printing systems.

### Preparing Training Set for Teaching a Neural Network to Detect C2C Registration Error

FIG. 2 is a schematic pictorial illustration of smoothing and resizing applied to a region 27 of ink image 23 for producing a corresponding region 28 at the same region of ink image 23, in accordance with an embodiment of the present invention.

In some embodiments, system 10 comprises a neural network (NN) (not shown), such as but not limited to a convolutional NN (CNN) or any other suitable type of NN. The NN may be implemented in processor 20 and/or in other processing devices (not shown) implemented in console 12 or in any other suitable computer (not shown) connected to or included in system 10. In the context of the present disclosure, the term neural network refers to any suitable artificial intelligence technique, such as but not limited to deep learning (DL) algorithm(s) and/or machine learning (ML) algorithm(s), which is implemented in hardware, software, or a suitable combination thereof.

In the present example, system 10 comprises a suitable NN accelerating device, such as but not limited to an A40, or an A100 graphics processing unit (GPU) provided by NVIDIA Corporate (2788 San Tomas Expressway Santa Clara, CA 95051). The NN accelerating device is configured to accelerate the operation of the NN during training and inference stages, so as to enable detection of C2C registration errors in a digital RGB image acquired by station 55 (or any other suitable image acquisition system or subsystem) from a printed image of digital image 42 shown in FIG. 1 above.

It is noted that a C2C registration error may be detected in one or more selected regions (also referred to herein as patches) of the digital RGB image having a sufficient number and size of structures overlapping one another. For example, region 27 has a subregion 29 intended to have a single color (e.g., cyan) or multiple colors in an area without pattern, and a subregion 30 with a pattern having two or more colors, e.g., cyan and magenta.

In some embodiments, subregion 30 is suitable for detecting C2C registration error between the cyan and magenta ink images (also referred to herein as color images or separations), e.g., images 23 and 24 of FIG. 1 above.

Subregion 29, however, cannot be used to detect any sort of C2C registration error. A gray level scale 36 of the cyan in region 27 is attached to the image of region 27.

Reference is now made to an inset 31 showing pixels 32 of a subregion 35 of region 27, it is noted that subregion 35 is shown for the sake of presentation, and the pixels 32 exist along the entire image with their respective gray levels. In some embodiments, when blanket 44 is being moved along the X-axis (direction 94), processor 20 is configured to control image forming station 60 to apply, from each nozzle 99 to each pixel 32 of the image formed on blanket 44, one of the following options: (i) zero droplets, (ii) one droplet, and (iii) two droplets. In the present example, when two droplets of cyan ink are applied to a pixel 32a, the gray level of the cyan color in pixel 32a is about 85 (and therefore, pixel 32a has a dark gray color), when one droplet of cyan ink is applied to a pixel 32b, the gray level of the cyan color in pixel 32b is about 170 (and therefore, pixel 32b has a gray color), and when no (i.e., zero) droplets of the cyan ink are applied to a pixel 32c, the gray level of the cyan color in pixel 32c is about 255 (and therefore, pixel 32c has a white color). Thus, in the example of inset 31, pixels 32 with cyan-gray levels 85, 170 and 255 are shown in black, gray, and white color, respectively. It is noted that checking C2C registration errors may result in false positive mistakes in such a grainy image, so that a smoothing of the image is required.

Reference is now made back to region 27. In some embodiments, processor 20 is configured to perform smoothing of region 27 of the image by applying to the image a filter, such as a gauss filter (configured to apply to each pixel 32 of region 27, a convolution with the surrounding pixels 32, in accordance with the gaussian distribution of the gray levels of the respective region), or any other suitable type of smoothing filter. Moreover, processor 20 is configured to adjust the size of region 27 to have the same number of pixels of an image of region 27 acquired by station 55. The resolution of region 27 is defined by the number of dots per square inch (dpi), which typically (but not necessarily) corresponds to the number of pixels in the respective region and in the entire image. In the present example, (i) the image of region 27 has about 1200 pixels along the Y-axis, and about 600 pixels along the X-axis, and (ii) the image acquired by station 55 has about 300 pixels in both X- and Y-axes. In this example, in addition to applying the gauss filter, processor 20 is configured to adjust the size of the image from 1200 pixels by 600 pixels of region 27, to about 300 pixels by 300 pixels in the corresponding region 28. The size adjustment of the region in question is important for training the NN, which is intended to receive from station 55, images of about 300 pixels by 300 pixels for detecting C2C registration errors in the inference stage, as will be described in more detail below.

In summary of the above embodiments, in FIG. 2 processor 20 is configured to produce the image of region 28 by applying smoothing and resizing to the image of the corresponding region 27. It is noted that the image of region 27 appears grainy and has three values of gray level (e.g., 85, 170 and 255), as shown in inset 31, whereas the image of region 28 appears smoother and has more continuous values of gray levels compared to that of the image of region 27.

FIG. 3 is a schematic pictorial illustration of the cyan droplets of region 28 are shown in gray levels of red, green, and blue images of region 28, in accordance with an embodiment of the present invention.

In some embodiments, processor 20 is configured to convert the gray level values in the gray level scale of the cyan ink of region 28, into different scales of gray levels in R, G, and B images of the corresponding region. More specifically, processor 20 is configured to apply regression and a polynomial fit transformation to the image of region 28 in order to produce simulations of: (i) an image 37 having a scale 41 showing the appearance of the pattern printed with cyan ink in the gray levels of the red color in a simulated red image acquired by station 55, ii) an image 38 having a scale 43 showing the appearance of the pattern printed with cyan ink, in the gray levels of the green color in a simulated green image acquired by station 55, and (iii) an image 39 having a scale 45 showing the appearance of the pattern printed with cyan ink, in the gray levels of the blue color in a simulated green image acquired by station 55.

Note that the cyan color is expressed differently in the gray levels of (the red) image 37, (the green) image 38, and (the blue) image 39, thus there is a difference between the gray level of scales 41, 43 and 45, respectively.

FIG. 4 is a schematic pictorial illustration of gray level images 37, 38 and 39 of region 28, converted to gradient images 47, 48 and 49 of region 28, respectively, in accordance with an embodiment of the present invention.

In some embodiments, processor 20 is configured to apply one or more gradient filters (also referred to herein as gradients) to each of images 37, 38 and 39 in order to produce gradient images 47, 48 and 49, respectively. More specifically, the gradient image displays the gradients of the cyan color in the red, green and blue gray levels. For example, gradient image 47 comprises the gradients of the cyan ink in gray levels of the red color.

In the present example, a Sobel filter is applied to each of images 37-39 for detecting and imaging the edges of the patterns of these images. The Sobel filter operates by calculating the gradient of image intensity at each pixel within the image.

In some embodiments, processor 20 is configured to produce the gradient in X- and Y-axes by applying the Sobel filter separately along the X-axis and along the Y-axis, respectively. In such embodiments, processor 20 is configured to produce two sets of gradient images 47, 48 and 49, a first set is produced by applying the Sobel filter along the X-axis, and a second set is produced by applying the Sobel filter along the Y-axis. In the example of FIG. 4, only one set is shown, e.g., the set in which the Sobel filter is applied to images 37-39 along the X-axis.

In some embodiments, gradient images 47, 48, and 49, have scales 51, 53 and 56, respectively. It is noted that the gray level distribution and scale alters responsively to the application of the Sobel filter. For example, scale 41 of image 37 has a range of gray levels between about 35 and 220, and the corresponding scale 51 of image 47 has a range of gray levels between about 0 and 80.

In such embodiments, processor 20 is configured to produce (i) gradient image 47 comprising the gradients of the cyan ink in the red gray level of image 37, (ii) gradient image 48 comprising the gradients of the cyan ink in the green gray level of image 38, and (iii) gradient image 49 comprising the gradients of the cyan ink in the blue gray level of image 379. It is noted that images 47, 48 and 49 are produced by applying the Sobel filter to the red gray level image 37, the green gray level image 38, and the blue gray level image 39, respectively.

Additionally, or alternatively to the Sobel filter, processor 20 is configured to apply any other suitable type of filter or algorithm to images 37-39 in order to produce gradient images 47-49, respectively.

FIG. 5 is a schematic pictorial illustration of an RGB gradient image 59 produced based on gradient images 47, 48 and 49 of region 28, in accordance with an embodiment of the present invention.

In some embodiments, processor 20 is configured to produce each pixel of RGB gradient image 59, for example by summing, or by applying any other mathematical manipulation to the gray level values of the corresponding pixels of gradient images 47-49. In such embodiments, the value of a scale 58 of the gray levels of RGB gradient image 59 equals to the summation of the values of scales 51, 53 and 56 of images 47, 48 and 49, respectively.

In some embodiments, processor 20 is configured to remove noise from image 59, by applying a filter, or using any other suitable technique. The filter may comprise a given threshold stored, for example, in the memory of processor 20.

In some embodiments, based on the filter, processor 20 is configured to produce a binary version of RGB gradient image 59, referred to herein as an image 61. For example, pixels having a gray level larger than the aforementioned given threshold (or any other suitable threshold stored in processor 20 or in a memory device of system 10), may receive a value “1” in image 61, and pixels having a gray level smaller than the aforementioned given threshold, may receive a value “0” in image 61.

In some embodiments, in addition to the given filter, processor 20 is configured to apply a suitable type of a connected components algorithm in order to remove from image 61 noise related to connected components in images 59 and 61. The connected components algorithm is configured to compute connected components for a given image having graphical patterns. Connected components are the set of its connected sub-graphical patterns. Such algorithms are available, for example, in a dynamic graph library known as GraphStream, which are described in more detail, for example, at https://graphstream-project.org/, the disclosure of these algorithms is incorporated herein by reference.

In the example of image 61, processor 20 is configured to map each of the connected components, (e.g., components 67) separately, in order to remove small connecting elements 65, for example. It is noted that image 61 comprises additional connecting elements that are not indicated with numeral 65.

In some embodiments, processor 20 is configured to produce an image 33 by removing from image 59, all the connecting elements (such as connecting elements 65). In the example of image 59, the connecting elements may have a gray level smaller than a predefined threshold that may be stored, for example, in the memory of processor 20 and/or in any memory device of system 10. In some embodiments, processor 20 is configured to perform the filtering of connecting elements 65 based on image 61, which is the binary version of RGB gradient image 59 along the X-axis.

In some embodiments, processor 20 is configured to perform the filtering of the connecting elements based on another image (not shown but is different from image 61), which is the binary version of the RGB gradient (not shown) along the Y-axis (corresponding to image 59). As described above, the images in FIGS. 2-5 are example images of the cyan color image (formed by applying the droplets of the cyan ink to blanket 44, and subsequently, transferred to sheet 50).

In some embodiments, processor 20 is configured to apply the same techniques to the binary versions (not shown) of all other RGB gradient images (corresponding to gradient images 59) along the X-axis.

Note that excess noise in RGB gradient 59 may reduce the detection accuracy of C2C registration errors in the respective regions (e.g., in region 28) of the color image produced by applying droplets of the cyan ink to blanket 44. In other words, the noise may increase the training resources (examples, iterations and time) required for concluding the training of the NN. Moreover, in the inference stage, the trained NN may have events of (i) false positive, in which the trained model of the NN incorrectly predicts, at a given pattern within a region, a C2C registration error that does not exist at the given pattern within the region, and/or (ii) false negative, in which the trained model of the NN fails to detect a C2C registration error that actually occurred in a given pattern within a region.

Based on the embodiments described above, processor 20 is configured to produce: (i) image 33, which is a first binary version of image 59, produced by applying the Sobel filter along the X-axis, and applying the given filter for converting continuous gray level of image 59 to image 61, which is the binary version of image 59, and (ii) a second binary version of an additional image (not shown) corresponding to image 59, produced by applying the Sobel filter along the Y-axis, and applying the given filter for converting continuous gray level of the additional image corresponding to image 59 to the binary version of additional image. In other words, the process described above for images 47-49, 59, 61 and 33 is carried out by applying (i) the Sobel filter along the Y-axis, and (ii) the other filters described above, for producing additional images corresponding to image 33.

In the present example, image 33 is also referred to herein as a Cx image or a first binary version of image 59 formed by applying the Sobel filter along the X-axis. Similarly, a second binary version of image 59 is also referred to herein as Cy image, which corresponds to image 33 and is formed by applying the Sobel filter to image 59 along the Y-axis.

Note that Cx image and Cy image are based on cyan image 23 (shown in FIG. 1) and more specifically, to region 27 described in FIG. 2 above and to the image processing techniques described in detail in FIGS. 2-5 above.

In some embodiments, processor 20 is configured to apply the same techniques, mutatis mutandis, to: (i) other regions in image 23, and (ii) region 27 and other regions in each of images 24, 25 and 26 (shown in FIG. 1 above) of the magenta, yellow and black colors, respectively, that are applied to blanket 44. In such embodiments, processor 20 is configured to produce Mx, Yx and Kx images, which are corresponding to the Cx image (i.e., image 33) and are produced by applying: (i) the Sobel filter along the X-axis, and (ii) all other image processing techniques described in FIGS. 2-5, to images 24, 25 and 26, respectively. Similarly, processor 20 is configured to produce My, Yy and Ky images, which are corresponding to the Cy image (not shown but described above) and are produced by applying: (i) the Sobel filter along the Y-axis, and (ii) all other image processing techniques described in FIGS. 2-5, to images 24, 25 and 26, respectively.

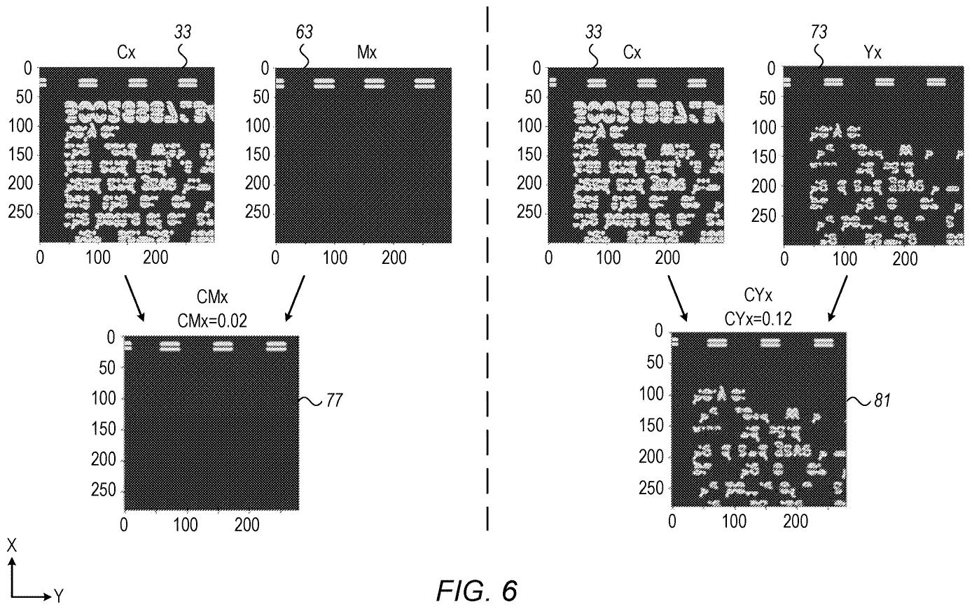

FIG. 6 is a schematic pictorial illustration of binary images 77 and 81 of region 27, produced by identifying joint patterns in (i) Cx and Mx, and (ii) Cx and Yx, respectively, in accordance with an embodiment of the present invention.

In some embodiments, processor 20 is configured to produce (i) image 77, which is an overlayed image formed by stacking or combining the binary Cx and binary Mx images, and (ii) image 81, which is an overlayed image formed by stacking or combining the binary Cx and binary Yx images.

In some embodiments, processor 20 is configured to identify joint patterns in each pair of images among the (i) Cx, Mx, Yx and Kx images, and among the (ii) Cy, My, Yy and Ky images. In the context of the present disclosure the terms “joint pattern” and “overlapping patterns” refer to patterns comprising a contiguous set of pixels having the value “1” in an overlayed image comprising a selected pair within the groups of images described above. More specifically, in the examples of FIG. 6, image 77 comprises the overlapping joint patterns of image 33 (the Cx) and an image 63, which is the Mx image produced by applying the techniques described in FIGS. 2-5 above, to region 27 (shown in FIG. 2 above) of the magenta image 24 (shown in FIG. 1 above).

In the context of the present disclosure, image 77 is also referred to herein as CMx, and in some embodiments, processor 20 is configured to calculate the number of pixels in the joint pattern in CMx, and the percentage of the pixels in the joint pattern among all the (e.g., 9000) pixels of image 77. In the present example, the pixels of the joint pattern of image 77, account for approximately 2% of the pixels of image 77.

In some embodiments, processor 20 is configured to produce image 81, also referred to herein as CYx, based on the overlapping patterns between image 33 and an image 73, also referred to herein as the Yx image. In the present example, the Yx image is produced by applying the techniques described in FIGS. 2-5 above, to region 27 (shown in FIG. 2 above) of the yellow image 25 (shown in FIG. 1 above).

In some embodiments, processor 20 is configured to calculate the number of pixels in the joint pattern in CYx, and the percentage of the pixels in the joint pattern among all the pixels of image 81. In the present example, the pixels of the joint pattern of image 81, account for approximately 12% of the pixels of image 81.

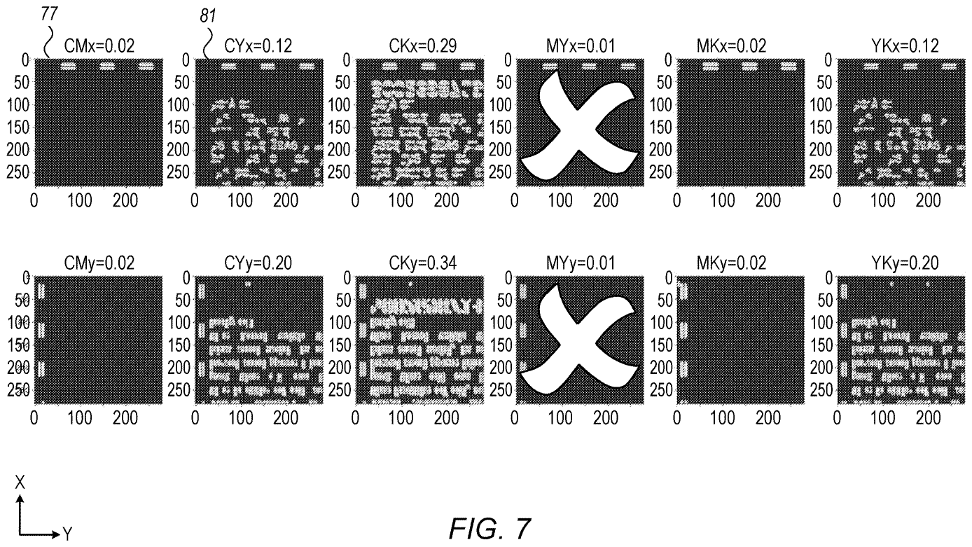

In some embodiments, processor 20 is configured to use the calculated percentage for determining one or more regions that may be used by the neural network for identifying C2C registration errors between selected pairs of separations. For example, region 27 for identifying C2C registration errors between the cyan image 23 and the magenta image 24 shown in FIG. 1 above. These techniques are shown in more images, and are described in more detail in FIG. 7 above.

FIG. 7 is a schematic pictorial illustration of a criterion for selecting binary images, which are suitable for training the neural network to detect C2C registration in digital images acquired by station 55, in accordance with an embodiment of the present invention.

In some embodiments, processor 20 is configured to apply the techniques described in FIGS. 2-6 to all the other pairs of images. More specifically, in addition to the CMx and CYx images, processor 20 is configured to produce: (i) a CKx image based on the Cx and Kx images, (ii) an MYx image based on the Mx and Yx images, (iii) an MKx image based on the Mx and Kx images, and (iv) a YKx image based on the Yx and Kx images. Moreover, processor 20 is configured to produce: (i) a CMy image based on the Cy and My images, (ii) a CYy image based on the Cy and Yy images, (iii) a CKy image based on the Cy and Ky images, (iv) an MYy image based on the My and Yy images, (v) an MKy image based on the My and Ky images, and (vi) a YKy image based on the Yy and Ky images.

In some embodiments, processor 20 is configured to calculate a level of overlap between structures that appear in both images of the above pairs (e.g., pattern that appears in both the binary Cx images and the binary Kx image). More specifically, each of the above images has a predefined number of pixels, e.g., about 9000 pixels (based on the sizing of region 28 to 300 pixels by 300 pixels as described in FIG. 2 above). Processor 20 is configured to calculate in each of the above images, the ratio between (i) the number of pixels that appear in the joint pattern, and (ii) the total number of (e.g., about 9000) pixels in the image. In other words, in the present example, processor 20 is configured to calculate, in the overlayed image, the percentage of the pixels that appear in the joint pattern out of the total number of pixels of the overlayed image, using the same technique applied to the CMx and CYx images, as described in detail in FIG. 6 above.

In some embodiments, processor 20 is configured to compare between (i) the level of overlap, e.g., the calculated percentage of the pixels in the joint pattern, and (ii) a predefined threshold. In the present example, the threshold is 0.02 (i.e., 2%), and in MYx and MYy the level of overlap is 0.01 (i.e., 1% of the pixels in each of the MYx and MYy images). In other words, only 1% of the pixels of each of the MYx and MYy images, appear in the joint pattern thereof. Therefore, MYx and MYy images of region 27, cannot be used for training the aforementioned one or more neural networks to detect the color registration error (C2C registration error) between the magenta image and the yellow image of region 27 in digital images acquired by station 55.

In some embodiments, the level of overlap in all other images of FIG. 7 (but MYx and MYy images) equals to or larger than the 0.02 threshold. Therefore, all these images can be used for training the one or more neural networks to detect the color registration error. More specifically, in the example of FIG. 7, the CMx image, the CYx image, the CKx image, the MKx image, the YKx image, the CMy image, the CYy image, the CKy image, the MKy image, and the YKy image can be used for training the one or more neural networks to detect the color registration error between the respective colors of each image. For example, in YKx and YKy, between yellow image 25 and black image 26 of region 27.

In some embodiment, based on the level of overlap, processor 20 is configured to determine one or more quality indices to region 27 for the training of the NN to detect C2C registration error between the respective pairs of colors. In other words, processor 20 is configured to apply a weight to each of the aforementioned images that can be used for training the one or more neural networks to detect the color registration error between the respective colors of each image. For example, when training the neural network to detect C2C registration error between the cyan and magenta colors, CKy image of region 27, whose level of overlap is 0.34 may receive a larger weight or quality index compared to another CKy image (not shown) produced based on a region other than region 27, whose level of overlap is substantially smaller, e.g., smaller than about 0.1. Moreover, based on the example images of FIG. 7, and the respective calculated levels of overlap, processor 20 is configured to assign to region 27: (i) a high-quality index for detecting C2C registration errors between the cyan and black colors, and (ii) a low-quality index for detecting C2C registration errors between the (a) magenta and black colors, and (b) the cyan and magenta colors.

Additionally, or alternatively, the techniques described in FIGS. 2-7 above, and more specifically, the criterion for selecting binary images and the output shown in FIG. 7, can be used, mutatis mutandis, in post processing of C2C registration output received from the neural network during the inference stage. For example, in case at the inference stage, the output of the neural network is indicative of a C2C registration error between the magenta image 24 and the yellow image 25 at region 27, processor 20 is configured to overrule or ignore this output when analyzing the C2C registration in image 42 between these separations.

Moreover, some of the regions (other than region 27) may not have one or more of the separations. For example, a given region in image 42 may not have the cyan image 23. In this example, the output of the neural network at the inference stage may be indicative of a C2C registration error between the cyan image 23 and the magenta image 24 at the given region. In some embodiments, based on the disclosed techniques, the level of overlap in CMx and CMy of the given region are below the 0.02 threshold (e.g., zero), and therefore, processor 20 is configured to overrule or ignore this output when analyzing the C2C registration in image 42 between the cyan and magenta separations.

The particular threshold (of 0.02), pattern of region 27, and output received in response to applying the algorithms and calculations described in FIGS. 2-7 above, are selected and shown by way of example, in order to illustrate certain problems that are addressed by embodiments of the present invention and to demonstrate the application of these embodiments in enhancing the performance of system 10 in training a neural network to detect C2C registration errors in images printed by the system. Embodiments of the present invention, however, are by no means limited to this specific sort of example: (i) system, (ii) pattern, (iii) region, (iv) colors, (v) system configuration, and (vi) parameters of the printing process, and the principles described herein may similarly be applied to any other sorts of digital printing systems, and images printed by such digital printing systems using any suitable configurations and parameters.

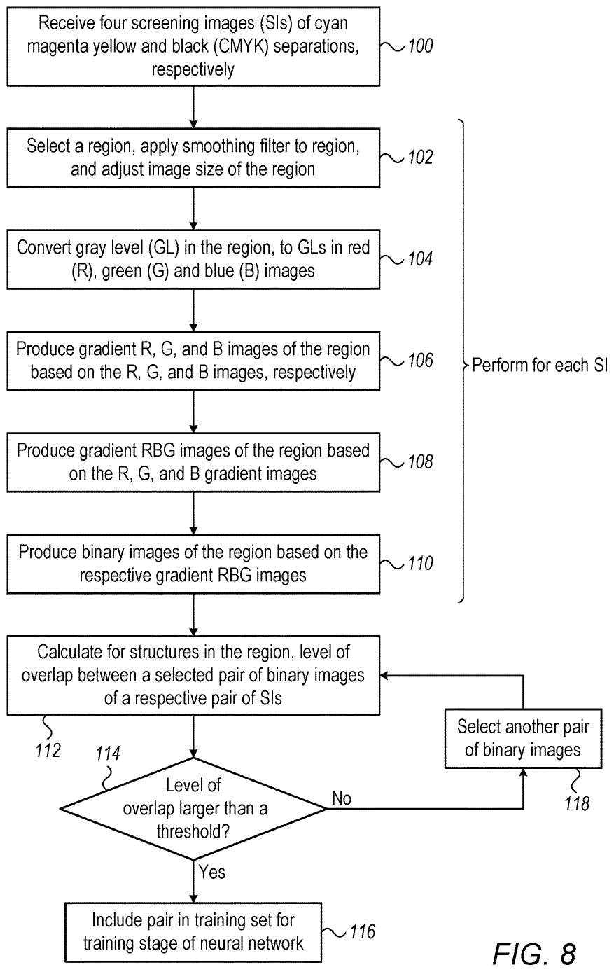

FIG. 8 is a flow chart that schematically illustrates a method for selecting a region of image 42 for training a neural network to detect color registration errors between two colors of image 42, in accordance with an embodiment of the present invention.

The method begins at a screening image (SI) receiving step 100, with processor 20 receiving SIs, also referred to herein as ink images 23, 24, 25 and 26, of the cyan, magenta, yellow and black separations, respectively. In some embodiments, processor 20 is further configured to produce ink images 23, 24, 25 and 26 during a screening process, for converting the RGB colors of image 42 to the aforementioned C, M, Y and K colors of images 23, 24, 25 and 26, as described in FIG. 1 above.

In the example of FIG. 8, steps 102, 104, 106, 108 and 110 below, are all applied to each of images 23, 24, 25 and 26. Moreover, as described in detail in FIGS. 2-5 above, steps 102, 104, 106, 108, and 110 of FIG. 8 have been applied to image 23 (the cyan ink image), and the same techniques can be applied, mutatis mutandis, to images 24, 25, and 26 of the magenta, yellow, and black ink images, respectively.

At region selection step 102, processor 20 selects one or more regions, such as region 27, in each of the ink images. It is noted that the same regions are selected in all images 23, 24, 25 and 26. In some embodiments, processor 20 applies to the selected regions: (i) one or more suitable smoothing filters, such as gauss filter, and (ii) resize the image of each of the selected regions, e.g., from 600 pixels by 1200 pixels, to 300 pixels by 300 pixels along the X- and Y-axes, respectively. As described in detail in the embodiments of FIG. 2 above, by applying the above filtering and resizing to region 27, processor 20 produces an image of region 28.

At gray level conversion step 104, processor 20 converts the gray level (GL) in the selected regions (e.g., the GLs of the cyan in the image of region 28), to GLs in red (R) image 37, green (G) image 38, and blue (B) image 39, as described in detail in the embodiments of FIG. 3 above.

At a first gradient image formation step 106, processor 20 applies to images 37, 38 and 39, one or more suitable algorithms and/or filters, such as but not limited to Sobel filter, for producing gradient images 47, 48 and 49, respectively. Moreover, as described in detail in FIG. 4 above, processor 20 applies the Sobel filter to images 37-39 (i) along the X-axis for producing gradient images 47-49, and (ii) along the Y-axis for producing additional gradient images (not shown but described in FIG. 4 above).

At a second gradient image formation step 108, processor 20 produces gradient RBG images of the regions of interest (e.g., region 27) based on the R, G, and B gradient images produced in step 106 above. For example, processor 20 produces gradient image 59 based on images 47-49, as described in detail in FIG. 5 above. Note that an additional RGB gradient image is produced based on the application of the Sobel filter to images 37-39 along the Y-axis, and summing the respective R, G, and B gradient images. Moreover, these RGB gradient images (e.g., gradient image 59 and the corresponding gradient image when applying the Sobel filter along the Y-axis) are formed based on region 27 of the cyan image 23, and the same process is applied to region 27 of the magenta image 24, yellow image 25, and black image 26, as described above. In such embodiments, processor 20 produces RGB gradient image 59 and additional seven RGB gradient images corresponding to the CMYK ink images after applying the Sobel filter along the X- and Y-axes.

At binary image formation step 110, processor 20 produces (i) binary image 61, which is a binary version of RGB gradient image 59, and (ii) binary image 33, by removing from image 59, all the connecting elements (such as connecting elements 65), as described in detail in FIG. 5 above. Note that the same process of step 110 is applied to the corresponding: (i) RGB image obtained when applying the Sobel filter to the cyan image along the Y-axis, and (ii) RGB images obtained when applying the Sobel filter to the magenta, yellow and black images along the X-axis and the Y-axis. In such embodiments, after concluding step 110, processor 20 produces eight binary images, such as image 33 and additional seven binary images corresponding to the CMYK ink images after applying the Sobel filter along the X- and Y-axes.

At an overlap level calculation step 112, processor 20 calculates, for structures in each of the selected regions, the level of overlap between twelve selected pairs of binary images of the SIs in each region. For example, processor 20 calculates, for the structures in region 27, the level of overlap in the twelve images that are produced by all combinations of pairs of binary images formed based on ink images 23-26 and shown in FIG. 7 above. More specifically, the level of overlap (e.g., percentage of pixels) is calculated for each of the CMx, CYx, CKx, MYx, MKx, YKx, CMy, CYy, CKy, MYy, MKy, and YKy images, as described in detail in FIGS. 6 and 7 above.

At a decision step 114, processor 20 checks whether the level of overlap exceeds the 0.02 threshold described in FIG. 7 above.

In some embodiments, the calculated level of overlap in both MYx and MYy images is about 0.01, i.e., smaller than the 0.02 threshold, and therefore, region 27 cannot be used for training the neural network(s) to detect C2C registration errors between the magenta image 24 and the yellow image 25 of FIG. 1, as described in detail in FIG. 7 above. In such embodiments, the method proceeds to a first selection step 118, in which processor 20 is configured to select another pair of binary images produced based on another region in the magenta image 24 and yellow image 25, and subsequently, the method loops back to step 112 for calculating the level of overlap in the other pair of binary images (which is produced based on the other region in the magenta image 24 and yellow image 25).

In other embodiments, the calculated level of overlap in other images (e.g., in the CMx, CYx, CKx, MKx, YKx, CMy, CYy, CKy, MKy, and YKy images) exceeds the 0.02 threshold. In such embodiments, the method proceeds to a second selection step 116, in which processor 20 selects the CMx, CYx, CKx, MKx, YKx, CMy, CYy, CKy, MKy, and YKy images that are produced based on region 27, for training the neural network(s) to detect C2C registration errors between any pair of images 23-26 of FIG. 1, other than the pair of magenta image 24 and the yellow image 25, as described in detail in FIG. 7 above.

In some embodiments, processor 20 is configured to apply the method iteratively, and to check whether sufficient examples have been collected for training the neural network(s) to detect C2C registration errors. After obtaining sufficient example, the last iteration of step 116 concludes the method.

### Improving Accuracy of Color-to-Color Registration Errors Estimated by a Neural Network

FIG. 9 is a schematic top view of color-to-color registration errors (C2C) estimated by a neural network (NN) in a red-green-blue (RGB) digital image 243, in accordance with an embodiment of the present invention.

In some embodiments, system 10 comprises a printing assembly having: (i) image forming station 60 (ii) impression station 84, and (iii) blanket module 70, which are described in detail in FIG. 1 above.

It is noted that for the sake of simplicity and conceptual clarity, the techniques and embodiments of the present disclosure that are described in FIGS. 9-13 below, are based on printed images comprising four colors of ink, e.g., cyan, magenta, yellow, and black (CMYK). The same techniques and embodiments are applicable, mutatis mutandis, to any other number and/or type of ink colors in other images intended to be printed in system 10 or in any other suitable digital printing system having an intermediate transfer member.

In some embodiments, processor 20 is configured to control: (a) the printing assembly to print image 42 on sheet 50, and one or more frames 221 that are typically printed on the edges of sheet 50, and (b) station 55 to acquire image 243, which is a digital RGB version of the printed version of digital image 42 shown in FIG. 1 above.

In some embodiments, the NN accelerating device is configured to accelerate the operation of the NN during training and inference stages, so as to enable detection and estimation of C2C in image 243.

In some embodiments, in the inference stage, the C2C is detected by the NN in one or more selected regions (also referred to herein as patches) of image 243 having a sufficient number and size of structures overlapping one another. In some embodiments, processor 20 is configured to illustrate, over image 243, a graphical representation of the estimated C2C in patches that are suitable for estimating the C2C. The selection of suitable patches may be carried out using various techniques, such as but not limited to a preprocessing technique described in detail in U.S. Provisional Patent Application 62/596,926, whose disclosure is incorporated herein by reference.

Reference is now made to an inset 228 showing regions 229, 230, 231 and 232 (also referred to herein as patches) in image 243. In the present example, in region 231, the RGB colors of one or more patterns are formed based on four colors of ink, e.g., cyan, magenta, yellow, and black (CMYK) applied by image forming station 60 to blanket 44, and subsequently, transferred to sheet 50. As such, the NN is configured to estimate the C2C between six pairs of the CMYK colors. More specifically, as shown in an inset 237 of region 231, the NN is configured to estimate: (i) a C2C 239 between the C and M, (ii) a C2C 241 between the C and Y, (iii) a C2C 247 between the M and K, (iv) a C2C 246 between the Y and M, (v) a C2C 248 between the Y and K, and (vi) a C2C 249 between the C and K.

Reference is now made to an inset 236 showing the C2Cs estimated in region 230. In the present example, the RGB colors of one or more patterns are formed based on two colors of ink, e.g., cyan, and magenta. As such, the NN is configured to estimate a C2C 251 between the C and M, and the other pairs of colors cannot be used by the NN for training and/or inference of the estimated C2C therebetween.

Reference is now made to an inset 238 showing the C2Cs estimated in region 229. In the present example, the RGB colors of one or more patterns are formed based on two colors of ink, e.g., cyan, and yellow. As such, the NN is configured to estimate a C2C 253 between the C and Y, and the other pairs of colors, cannot be used by the NN for training and/or inference of the estimated C2C therebetween.

In some embodiments, based on estimated C2C 251 (between C and M), and C2C 253 (between C and Y), processor 20 is configured to estimate a C2C 256 between Y and M.

In the present example, region 232 does not have a pattern comprising two or more colors of ink among the CMYK colors. Therefore, region 232 cannot be used in the training and/or inference of the NN to detect and estimate C2C between pairs of ink color.

In some embodiments, at least one of, and typically all frames 221, comprise marks 224, 225, 226 and 227 of the C, M, Y and K colors of ink, respectively. In the present example, marks 224, 225, 226 and 227 are arranged at predefined nominal distances (i) from a center of gravity (COG) 223 (of frame 221), and (ii) from one another. It is noted that the nominal distances refer to the design of frames 221 without any distortion, such as but not limited to C2C, occurring while printing digital image 42.

Reference is now made to an inset 258 showing marks 224, 225, 226 and 227 of a frame 221a. In the present example, a distortion occurred in flexible blanket 44, and results in shifts in the positions of one or more of marks 224, 225, 226 and 227, relative to the nominal positions shown in inset 235 described above. In other words, the arrangement of marks 224-227 in inset 235 is indicative of minor or zero C2Cs, whereas the arrangement of marks 224-227 in inset 258 is indicative of one or more C2Cs between one or more pairs of the ink colors of image 243. Moreover, it is noted that a region 259 does not have a pattern comprising two or more colors of ink among the CMYK colors. Therefore, region 259 in image 243 cannot be used in the training and/or inference of the NN to detect and estimate C2C between pairs of colors selected among the C, M, Y and K colors of ink.

In some embodiments, based on analysis of information obtained from frames 221 and 221a, processor 20 is configured to estimate C2Cs in the CMYK colors, and optionally, a distortion in blanket 44 that may at least partially contribute to the C2C. In one implementation processor 20 is configured to insert a constant offset to each registration mark so as to align marks 224-227 to a common position, e.g., at COG 223 of frame 221. Processor 20 is further configured to produce, based on the registration frames and registration marks, a set of interpolated curves between the respective marks of each color, for example between marks 225 of all frames 221 and 221a.

As described above, in the design of frames 221 and 221a, there is a deliberate shift between the registration marks so that they will not be printed on top of one another. In some embodiment, processor 20 is configured to align the location of all the registration marks of each frame to the common position per the predetermined graphics offset, and subsequently, to determine which registration mark is shifted (e.g., relative to the COG).

The interpolated curves are referred to herein as wave profile curves representing the shift distortion occurred during the printing for each respective color of system 10. The term “wave profile curve” is also referred to below simply as “curve” or “wave” for brevity. It is noted that the wave may occur along the X-axis (also referred to herein as a wave X), and/or along the Y-axis (also referred to herein as a wave Y).

In some embodiments, processor 20 is configured to produce, based on marks 224-227 of frames 221, four curves (not shown) corresponding to the four colors of marks 224-227. The technique described above, and other suitable techniques for estimating C2C based on marks located at suitable positions on sheet 50 (e.g., at the edge of the image), are described in more detail, for example, in U.S. Patent Application Publication number 2021/0309020, in U.S. Pat. No. 11,321,028, and in U.S. Patent Application Publication number 2019/015221, whose disclosures are all incorporated herein by reference.

In some embodiments, interface 22 is configured to receive, for at least one of the pairs, and typically for all the pairs of the CMYK colors formed in the regions of image 243, a dataset comprising: (i) the C2Cs estimated by the NN between the colors of the pairs, (ii) a confidence level of each of the estimated C2Cs, and (iii) a location of each of the pair in XY coordinates of image 243.

In some embodiments, the confidence level of each estimated C2C is obtained from the NN based on a predicted variance of C2C. More specifically, when the predicted variance of C2C is relatively small (e.g., about 0.1), the confidence level is relatively high (e.g., about 1), and when the predicted variance of C2C is relatively large (e.g., about 0.9), the confidence level is relatively low (e.g., about 0.2).

In some embodiments, interface 22 is configured to receive, e.g., from station 55 or from any other suitable source, an additional dataset, which is based on the locations of marks 224-227 in at least one of, and typically in all frames 221. The additional dataset is indicative of an additional distortion occurring in image 243.

In some embodiments, based on at least the dataset received from the NN, and in some cases, the additional dataset described above, processor 20 is configured to estimate a distortion occurring in blanket 44.

As described above, based on the color scheme of the printed image and the aforementioned preprocessing, some of the regions of image 243 may not have all the colors of ink. For example, each of regions 229 and 230 has only one C2C estimated by the NN between a single pair of colors, and regions 232 and 259 do not have any C2C estimated by the NN.

In some embodiments, before the printing process of image 42, processor 20 is configured to receive image 42, e.g., via interface 22. During a screening process that may be carried out by processor 20 or by any other processing unit, the digital color image 42 is converted into multiple color images, also referred to herein as screening images (SIs) of the colors of ink intended to be applied to the blanket for producing image 243 thereon. In the present example, image 243 is formed using four colors of ink: cyan (C), magenta (M), yellow (Y) and black (K), and therefore, after the screening process, processor 20 receives C, M, Y and K images. In other examples, the image may be formed using any other suitable number on ink colors, e.g., seven colors.

In some embodiments, in the preprocessing stage (before the NN is applied to image 243), processor 20 is configured to: (i) produce RGB gradient images based on the screening images of each of the C, M, Y and K colors, (ii) select first and second RGB gradient images of first and second colors (e.g., cyan and magenta, respectively), and (iii) calculate a level of overlap between first and second structures appearing in the RGB gradient images of the first and second colors, respectively. It is noted that the RGB gradient images for each color comprise (i) a first RBG image having the gradient applied along the X-axis (e.g., denoted Cx for the cyan SI, and Mx for the magenta SI), and (ii) a second RBG image having the gradient applied along the Y-axis (e.g., denoted Cy for the cyan SI, and My for the magenta SI).

For example, for each region selected in the cyan and magenta SIs, processor 20 is configured to calculate the level of overlap between (i) the structures appearing in the Cx and Mx images, and (ii) the structures appearing in the Cy and My images.

In some embodiments, processor 20 is configured to compare between the calculated level of overlap and a predefined threshold. Moreover, for the training and the inference stages of the NN, processor 20 is configured to select a given region whose level of overlap exceeds the predefined threshold. For example, in case the level of overlap between the structures appearing in the Cx and Mx images of the given region, exceeds the predefined threshold, the given region will be selected by processor 20 for training the NN and also in the inference stage, to detect C2C between the cyan and magenta images along the X-axis. In case the calculated level of overlap between a given pair of RGB gradient images of a selected region is smaller than the threshold, processor 20 assigns a validity mask to the selected region for the given pair. In other words, the selected region is invalid, and could not be used by the NN for estimating C2C, both in the training and inference stages. As such, in regions 229, 230 and 232 at least one pair of the RGB gradient images (of different colors) may not be used for estimating C2C by the NN, in case the level of overlap between the structures appearing in these RGB gradient images is smaller than the threshold, or at least one of these colors is not intended to be printed in at least one of regions 229, 230 and 232.

In some embodiments, processor 20 is configured to apply weighting factors to the data received from (i) the NN-dataset, and (ii) the additional dataset, for estimating the distortion occurring in blanket 44. For example, (a) in region 231 the dataset received from the NN comprises six C2Cs estimated between six respective pairs of all the four CMYK colors of ink. As such, in region 231, processor 20 may apply a larger weighting factor to the NN-based dataset compared to that of the additional dataset received from frames 221, (c) in regions 229 and 230, processor 20 may apply a similar weighting factor to the dataset and the additional dataset, and (c) in region 259, processor 20 may apply a larger weighting factor to the additional dataset that is based on frames 221 and 221a, compared to that of the dataset received from the NN in the regions surrounding region 259.

In other embodiments, in case most or all the regions of image 243 exclude a given color (e.g., black), then for C2C estimation between (i) the black color, and (ii) one or more of the other colors of image 243, processor 20 may use only the additional dataset obtained based on frames 221. In other words, when in the dataset received from the NN, at least one of (i) the estimated C2C between a given pair of colors does not exist, or (ii) the confidence level of the estimated C2C between the given pair of colors, is below a given threshold, processor 20 is configured to use only the additional dataset received from frames 221 for estimating: (a) the C2C between the given pair of colors, or (b) the distortion occurring in blanket 44.

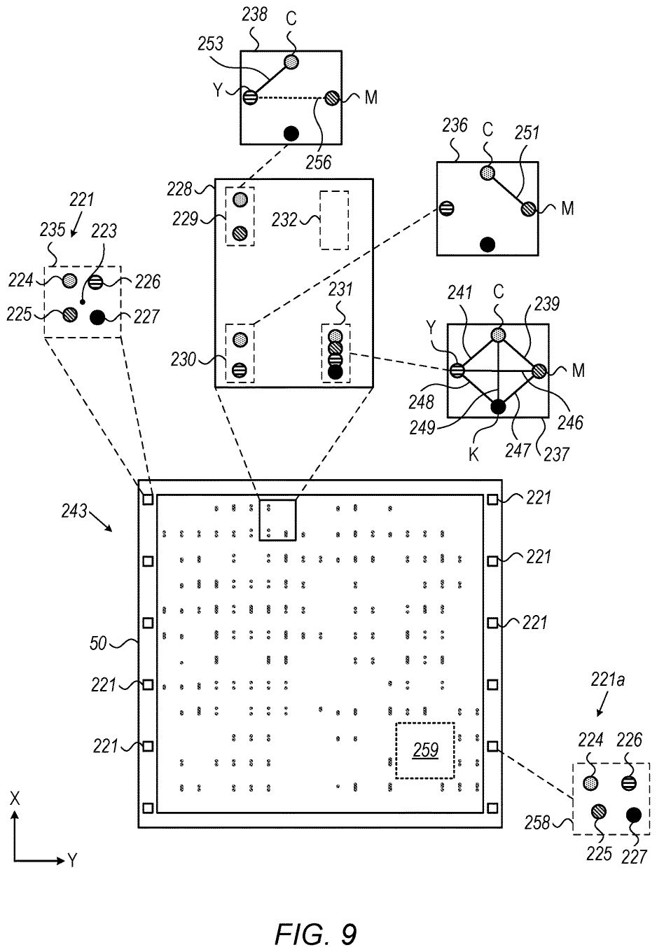

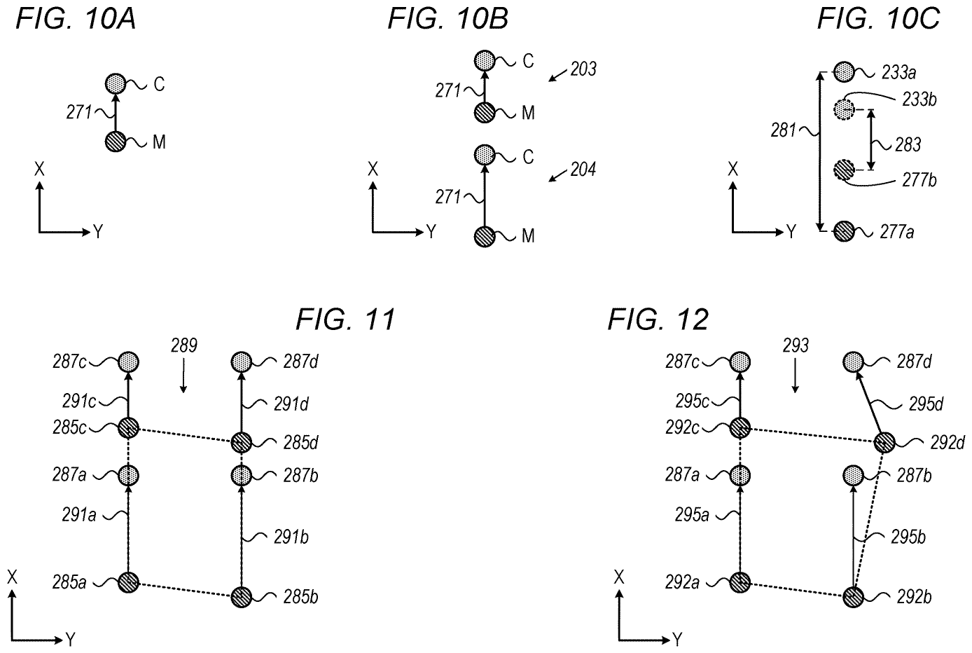

In some embodiments, processor 20 is configured to estimate at least the distortion in blanket 44, using a linear model or a non-linear model, which are described in detail in FIGS. 10A-12 below. Moreover, based on: (i) the C2C estimation received from the NN, and (ii) the additional dataset obtained based on the positions of marks 224-227 of frames 221, processor 20 is configured to produce an improved estimation of the C2C between at least one of the pairs of colors, and typically for each pair of the ink colors among the CMYK colors of ink. It is noted that at least some of, and typically all the distortions (e.g., C2C, and distortion in blanket 44) are not related to the pattern of the image. Therefore, the estimated C2C and blanket distortion are applicable for correcting several types of distortions in image 243 (which is based on image 42), and in other images printed using system 10 or any other suitable type of a digital printing system having a deformable intermediate transfer member.

### Applying Linear Models for Estimating Distortion Occurring in Blanket

FIGS. 10A, 10B and 10C are schematic illustrations of linear models for estimating distortions occurring in blanket 44 of system 10, in accordance with an embodiment of the present invention. In the present examples, the linear models are applied to the estimated C2C received from the NN. Moreover, the models also use (i) the confidence level for each estimated C2C, and (ii) the location of each pair of colors, provided in the aforementioned dataset received from the NN, which are described in FIG. 9 above.

As described above, for the sake of simplicity and conceptual clarity, the techniques described in FIGS. 10A-10C, and in FIGS. 11-13 below, are based on printed images comprising four colors of ink, e.g., CMYK. The same techniques are applicable, mutatis mutandis, to any other number of ink colors (e.g., seven colors of ink).

Reference is now made to FIG. 10A. In some embodiments, processor 20 is configured to estimate in each region, C2C between any pair of color images that passed the preprocessing stage described in FIG. 9 above. In the present example, the pair of color images comprises cyan and magenta, and processor 20 is configured to estimate the C2C registration by applying a relative shift to one of the color images along the X-axis, which is parallel to the direction of motion of blanket 44.

It is noted that the maximum number of pairs of colors (NCP) is calculated by equation (i):

$${N}_{CP} = ( {N}_{C} * ( {N}_{C} - 1 ) ) / 2 \qquad ( i )$$

wherein Nc denotes the number of colors.

As such, an image of four colors has a maximum of six pairs of colors, and an image of seven colors has a maximum of twenty-one pairs of colors.

As described in FIG. 9 above, processor 20 is configured to also use the location of each patch in the calculation of the C2C and/or distortion of blanket 44. Variables xc, xm, xy, xk are referred to herein as the nominal positions of the C, M, Y, and K in the designed pattern of a given patch (e.g., region 231) of image 243. Moreover, variables ^{~}xc, ^{~}xm, ^{~}xy, and ^{~}xk are referred to herein as the positions of the C, M, Y, and K estimated by the NN. As such, region 231 has all four CMYK colors, and therefore, six pairs of these colors, as shown in the matrix of equation (ii):

$$\{ \begin{matrix}xc - xm = {}^{\sim} xc - {}^{\sim} xm \\ xc - xy = {}^{\sim} xc - {}^{\sim} xy \\ xc - xk = {}^{\sim} xc - {}^{\sim} xk \\ xm - xy = {}^{\sim} xm - {}^{\sim} xy \\ xm - xk = {}^{\sim} xm - {}^{\sim} xk \\ xy - xk = {}^{\sim} xy - {}^{\sim} xk\end{matrix} \qquad ( ii )$$

The left-hand side of equation (ii) for a patch “i” (i.e., a region “i”) having all possible valid pairs is shown in an equation (iii):

$${A}_{{p}_{i}} = ( \begin{matrix}1 & - 1 & 0 & 0 \\ 1 & 0 & - 1 & 0 \\ 1 & 0 & 0 & - 1 \\ 0 & 1 & - 1 & 0 \\ 0 & 1 & 0 & - 1 \\ 0 & 0 & 1 & - 1\end{matrix} ) \qquad ( iii )$$

wherein Aₚᵢ denotes the number of pairs for a given patch in image 243 between patch number 1 and patch number n.
The nominal positions of variables xc, xm, xy, xk, are indicative of shifts required along the X-axis for correcting the respective C2Cs. In the example of FIG. 10A, a shift is required for correcting a C2C 271 between the magenta and cyan. It is noted that in the example of FIG. 10A, all the regions of image 243 are assumed to have the same level of C2C 271, and therefore, the same shift is applicable to all the pairs of cyan and magenta of these regions. Based on the required shift for correcting C2C 271, processor 20 is configured to estimate the C2C between the magenta and cyan. Thus, variables xc, xm, xy, xk, are not known, and are defined in a vector X of equation (iv):

$$X = ( \begin{matrix}x c \\ x m \\ x y \\ x k\end{matrix} ) \qquad ( iv )$$

In some embodiments, processor 20 is configured to solve multiple equations comprising variables xc, xm, xy, and xk, in order to calculate the values thereof, and thereby, to estimate the values of the C2Cs between the pairs of colors.

The right-hand side of equation (ii) for a patch “i” (i.e., a region “i”) having all possible valid pairs is shown in an equation (v):

$${y}_{{p}_{i}} = ( \begin{matrix}{}^{\sim} xc - {}^{\sim} xm \\ {}^{\sim} xc - {}^{\sim} xy \\ {}^{\sim} xc - {}^{\sim} xk \\ {}^{\sim} xm - {}^{\sim} xy \\ {}^{\sim} xm - {}^{\sim} xk \\ {}^{\sim} xy - {}^{\sim} xk\end{matrix} ) \qquad ( v )$$

As such, the matrix equation for single patch pi is provided in an equation (vi):

$${Ap}_{i} X = {y}_{pi} \qquad ( vi )$$

A matrix equation (vii) generalizes equation (vi) for patches 1 to n of image 243:

$$( \begin{matrix}{Ap}_{1} \\ … \\ {Ap}_{n}\end{matrix} ) X = ( \begin{matrix}{yp}_{1} \\ … \\ {yp}_{n}\end{matrix} ) \qquad ( vii )$$

It is noted that the preprocessing stage described above creates for each patch validity mask (in the present example, a vector) of the same size of N_{CP}. It can consist of all 1's, all 0's or any suitable combination of ones and zeros. For example, a vector Vpᵢ is indicative of the validity mask is provided in an equation (viii):

$${V}_{{p}_{i}} = ( \begin{matrix}0 \\ 1 \\ 0 \\ 0 \\ 1 \\ 1\end{matrix} ) \qquad ( viii )$$

As such, in regions having the one or more zero value in the vector Vpᵢ the respective pairs are discarded, and are not being used in the inference stage of the NN, and in the post processing of the estimated C2C received from the NN. For example, pairs CM, CK, and MY are discarded based on the vector Vpᵢ of equation (viii).

In some embodiments, based on the number of regions (which is typically on the order of hundreds or thousands), and the number of valid pairs for each region, processor 20 is configured to produce a sufficient number of equations for calculating the values of variables xc, xm, xy, and xk, and thereby, for estimating the required shifts (such as the shift required for correcting C2C 271), and the C2Cs between the six pairs of the CMYK colors.

Reference is now made to FIG. 10B showing C2C between cyan and magenta in regions 203 and 204 located along the X-axis. It is noted that the C2C may occur, inter alia, due to a mismatch between the movement speed of blanket 44 and the timing of jetting the different colors (e.g., CMYK) of ink, resulting in C2C 271 along the X-axis. Additionally, or alternatively, the C2C may occur due to a distortion in blanket 44. For example, blanket 44 is flexible, so that a non-uniform force applied to blanket 44 (while being moved) along the X-axis, may cause a non-uniform stretching of blanket 44 along the X-axis, and may result in altering magnification between the colors of image 243 that may increase the level of C2C between two or more pairs of the CMYK colors.

In the example of FIG. 10B, (i) in region 203, the level of C2C 271 between the cyan and magenta equals the level of C2C 271 shown also in FIG. 10A above, and (ii) in region 204, the level of a C2C 272 between the cyan and magenta is larger than that of C2C 271. As such, C2C 271 is caused solely by the mismatch between the movement speed of blanket 44 and the timing of jetting the cyan and magenta, and C2C 272 is cause by a combination of: (i) the mismatch between the movement speed of blanket 44 and the timing of jetting the cyan and magenta (which can be modeled and corrected using shift), and (ii) the non-uniform stretching of blanket 44 along the X-axis (which can be modeled and corrected using a different level of scaling factor, e.g., along the X-axis). Thus, shift alone is not sufficient for estimating the C2C between the cyan and magenta colors, and in some cases both a shift and a scaling factor are required for the linear modeling (and for the correction) of the C2C between the cyan and magenta.

In some embodiments, processor 20 is configured to estimate one or more scaling factors for altering the magnification in the regions located along the X-axis, for at least one of (and typically all) the colors of these regions. It is noted that the shift is relative to a reference point. In the example of FIG. 10B C2C 271 of the magenta color is estimated relative to the position of the cyan color, which serves as the reference point. The scaling factor may be altered along the X-axis of blanket 44, and may be calculated relative to a different reference point, such as any selected origin of a predefined coordinate system, as will be described in FIG. 10C below.

Reference is now made to FIG. 10C illustrating a linear model used for estimating a combination of the shift and scaling factor between the cyan and magenta colors. In the present example, circles 2233a and 22277a are indicative of the detected (e.g., measured) positions of the cyan and magenta colors in a predefined region of image 243, respectively. Circles 233b and 2277b are indicative of the nominal positions of the cyan and magenta colors in the predefined region of image 243, respectively.

As such, a distance 281 is indicative of the measured distance between circles 233a and 2277a, and a distance 283 is indicative of the nominal distance between circles 233b and 277b.

In some embodiments, processor 20 is configured to estimate the shift and scaling factor described above in the predefined region for the pair of cyan and magenta colors. The estimation is carried out by solving a plurality of the following equations using a technique described herein.

In the description below, the predefined region is referred to herein as a “center patch” having coordinates x⁰ₚ in image 243. In some embodiments, distance 283 that is already measured, is calculated using an equation (ix):

$${}^{\sim} {x}_{c} - {}^{\sim} {x}_{m} = {x}_{c}^{0} - {x}_{m}^{0} + {S}_{c} ( {x}_{p} - {x}_{p}^{0} ) - {S}_{m} ( {x}_{p} - {x}_{p}^{0} ) \qquad ( ix )$$

wherein:
   ^{~}x_{c} denotes the measured position of circle 233a,
^{~}xₘ denotes the measured position of circle 2277a,

$${x}_{c}^{0}$$

denotes the estimated shift in the position of circle 233b relative to the nominal position thereof,

$${x}_{m}^{0}$$

denotes the estimated shift in the position of circle 277b relative to the nominal position thereof,
S_{c} denotes the scale of the cyan,
Sₘ denotes the scale of the magenta, and

$${x}_{p} - {x}_{p}^{0}$$

represents a distance dₚ between the current patch and the origin (considered as the scaling origin) of the coordinate system.

It is noted that variables

$${x}_{c}^{0} , {x}_{m}^{0} , {S}_{c} , and {S}_{m}$$

of equation (ix) are not known, and could be calculated by processor 20 using the following equations. Moreover, for the full set of CMYK colors, the variables

$${x}_{y}^{0} , {x}_{k}^{0} , {S}_{y} , and {S}_{k}$$

are also unknown.

In an equation (x) the term dₚ is inserted into equation (iii) above:

$${A}_{{p}_{i}} = ( \begin{matrix}1 & - 1 & 0 & 0 & {d}_{p} & - {d}_{p} & 0 & 0 \\ 1 & 0 & - 1 & 0 & {d}_{p} & 0 & - {d}_{p} & 0 \\ 1 & 0 & 0 & - 1 & {d}_{p} & 0 & 0 & - {d}_{p} \\ 0 & 1 & - 1 & 0 & 0 & {d}_{p} & - {d}_{p} & 0 \\ 0 & 1 & 0 & - 1 & 0 & {d}_{p} & 0 & - {d}_{p} \\ 0 & 0 & 1 & - 1 & 0 & 0 & {d}_{p} & - {d}_{p}\end{matrix} ) \qquad ( x )$$

The unknown variables of the shift and scaling described above (after defining dₚ) are presented in a vector X of an equation (xi):

$$X = ( \begin{matrix}{x}_{c} \\ {x}_{m} \\ {x}_{y} \\ {x}_{k} \\ {S}_{c} \\ {S}_{m} \\ {S}_{y} \\ {S}_{k}\end{matrix} ) \qquad ( xi )$$

The respective right-hand side is presented in an equation (xii):

$${y}_{{p}_{i}} = ( \begin{matrix}{}^{∼} xc - {}^{∼} xm \\ {}^{∼} xc - {}^{∼} xy \\ {}^{∼} xc - {}^{∼} xk \\ {}^{∼} xm - {}^{∼} xy \\ {}^{∼} xm - {}^{∼} xk \\ {}^{∼} xy - {}^{∼} xk\end{matrix} ) \qquad ( xii )$$

As such, the matrix equation for a given patch pᵢ is presented in an equation (xiii):

$${A}_{{p}_{i}} X = {y}_{{p}_{i}} \qquad ( xiii )$$

And the matrix equation for all patch p₁-pₙ is presented in an equation (xiv):

$$( \begin{matrix}{Ap}_{1} \\ … \\ {Ap}_{n}\end{matrix} ) X = ( \begin{matrix}{yp}_{1} \\ … \\ {yp}_{n}\end{matrix} ) \qquad ( xiv )$$

A few manipulations of equation (xiv) provide:
AX=y, followed by A^{T}WAX=A^{T}WAy
wherein
AX and Ay denote the matrices presented in equation (xiv),
A^{T} denotes the transpose matrix of A, and
W denotes a weighting factor provided by the NN, which is indicative of the confidence level of the estimated C2C between each pair of colors, as described in detail in FIG. 9 above.

As such, the unknown variable of vector X of equation (xiv) above, could be calculated using an equation (xv):

$$X = {( {A}^{T} WA )}^{- 1} {A}^{T} WAy \qquad ( xv )$$

In some embodiments, based on the equations described above, processor 20 is configured to estimate the combination of the shift and scaling factor for each pair of colors, based on the calculated nominal locations and nominal distance between the colors of each pair. In the example of FIG. 10C, the combination of the shift and scaling factor between the cyan and magenta colors could be estimated by calculating the nominal locations of circles 233b and 277b, and nominal distance 283.

In some embodiments, by solving the equations for marks 224-228 of frames 221 and 221a (also referred to herein as AQM targets), it is possible to add information about the distortion of blanket 44.

The measured positions of mark 224 (the cyan AQM target), and mark 225 (the magenta AQM target) are provided using an equation (xvi):

$$\{ \begin{matrix}{∼}^{} {x}_{c} = {x}_{c}^{0} + {S}_{c} {x}_{c}^{p} \\ {}^{∼} {x}_{m} = {x}_{m}^{0} + {S}_{m} {x}_{m}^{p}\end{matrix} \qquad ( xvi )$$

Wherein,

$${S}_{c} {x}_{c}^{p}$$

denotes the scale of the cyan mark 224 multiplied by the distance between the cyan mark 224 and the origin of the coordinate system, and

$${S}_{m} {x}_{m}^{p}$$

denotes the scale of the magenta mark 225 multiplied by the distance between the magenta mark 225 and the origin of the coordinate system.

After subtracting the distance from the origin of the cyan

$$( {x}_{c}^{p} )$$

and the magenta

$$( {x}_{m}^{p} )$$

from both sides of the cyan and magenta sub-equations of equation (xvi), respectively, and subtracting the magenta sub-equation from the cyan sub-equation, obtains an equation (xvii):

$${∼}^{} {x}_{c} - {}^{∼} {x}_{m} - {d}_{cm}^{p} = {x}_{c}^{0} - {x}_{m}^{0} + ( {s}_{c} - 1 ) {x}_{c}^{p} - ( {s}_{m} - 1 ) {x}_{m}^{p} \qquad ( xvii )$$

Wherein,

$${d}_{cm}^{p}$$

denotes the nominal distance between the cyan mark 224 and the magenta mark 225,

$${x}_{c}^{p}$$

denotes the distance of the cyan mark 224 from the origin of the coordinate system, and

$${x}_{m}^{p}$$

denotes the distance of the magenta mark 225 from the origin of the coordinate system.

The variables to be calculated are

$${x}_{c}^{0} , {x}_{m}^{0} , and {s}_{c} - 1 , and {s}_{m} - 1 ,$$

which are the shift and the scale in the cyan mark 224 and in the magenta mark 225.

As such, the matrix of all marks 224-227 in all frames 221 (of the AQM targets) is provided by an equation (xviii):

$${A}_{{p}_{i}} = ( \begin{matrix}1 & - 1 & 0 & 0 & {x}_{c}^{p} & - {x}_{m}^{p} & 0 & 0 \\ 1 & 0 & - 1 & 0 & {x}_{c}^{p} & 0 & - {x}_{y}^{p} & 0 \\ 1 & 0 & 0 & - 1 & {x}_{c}^{p} & 0 & 0 & - {x}_{k}^{p} \\ 0 & 1 & - 1 & 0 & 0 & {x}_{m}^{p} & - {x}_{y}^{p} & 0 \\ 0 & 1 & 0 & - 1 & 0 & {x}_{m}^{p} & 0 & - {x}_{k}^{p} \\ 0 & 0 & 1 & - 1 & 0 & 0 & {x}_{y}^{p} & - {x}_{k}^{p}\end{matrix} ) \qquad ( xviii )$$

### Applying Non-Linear Models for Estimating Distortion Occurring in Blanket

FIGS. 11 and 12 are schematic illustrations of non-linear models for estimating a distortion occurring in a blanket of the system of FIG. 1, in accordance with an embodiment of the present invention.

In the present examples, the non-linear models are applied to the estimated C2C received from the NN. Moreover, the models also use (i) the confidence level for each estimated C2C, and (ii) the location of each pair of colors, provided in the aforementioned dataset received from the NN, which are described in FIG. 9 above.

Reference is now made to FIG. 11 showing magenta patterns 285a, 285b, 285c and 285d, and cyan patterns 287a, 287b, 287c and 287d. It is noted that the arrangement of a first structure comprising the magenta patterns, and a second structure comprising the cyan patterns, are both intended to have nominal shapes of a rectangle. In the present example, the combination of shift and magnification errors described above causes distortion in the shape of the first structure of the magenta patterns, relative to that of the cyan patterns. More specifically, a structure 289 (shown in a broken-line frame) comprising magenta patterns 285a-285d has a parallelogram shape, rather than having the nominal rectangular shape.

In the present example, a C2C 291a between magenta pattern 285a and cyan pattern 287a is smaller than a C2C 291b between magenta pattern 285b and cyan pattern 287b. Moreover, a C2C 291c between magenta pattern 285c and cyan pattern 287c is smaller than a C2C 291d between magenta pattern 285d and cyan pattern 287d. The C2Cs are different along the X-axis between the first pairs of cyan and magenta patterns (as shown in FIG. 10B above), but are also altered along the Y-axis, between second pairs of cyan and magenta patterns located along the X-axis.

In some embodiments, in order to represent the parallelogram shape of structure 289, processor 20 is configured to apply an affine transformation to at least the regions of image 243 that are shown in FIG. 11. Moreover, processor 20 is configured to apply the affine transformation for: (i) estimating the non-linear distortion in blanket 44, resulting in the different levels of C2C among C2Cs 291a-291d, (ii) correcting the C2Cs 291a-291d by “altering the location” of the magenta patterns solely along the X-axis to the location of the corresponding cyan patterns (e.g., “altering the location” of magenta pattern 285a, along the X-axis, to the location of cyan pattern 287a).

It is noted that in the example of FIG. 11, the affine transformation is applicable to produce the non-linear model of C2C occurring along the X-axis.

Moreover, the structure formed by the combination of cyan patterns 287a-287d appears to have a rectangular shape for the sake of presentation and conceptual clarity, but may have any other suitable shape (which is caused by the distortion of blanket 44).

Reference is now made to FIG. 12 showing magenta patterns 292a, 292b, 292c and 292d, and cyan patterns 287a, 287b, 287c and 287d (note that the cyan patterns are similar to that of FIG. 11 above for the same of the presentation below). It is noted that the arrangement of a first structure comprising the magenta patterns, and a second structure comprising the cyan patterns, are both intended to have nominal shapes of a rectangle. In the present example, the combination of shift and magnification errors described above causes distortion in the shape of the first structure of the magenta patterns, relative to that of the cyan patterns. More specifically, a structure 293 (shown in a broken-line frame) comprising magenta patterns 292a-292d has a trapezoid shape, rather than having the nominal rectangular shape.

In the present example, a C2C 295a between magenta pattern 292a and cyan pattern 287a is smaller than a C2C 295b between magenta pattern 292b and cyan pattern 287b. Moreover, a C2C 295c between magenta pattern 292c and cyan pattern 287c is smaller than a C2C 295d between magenta pattern 292d and cyan pattern 287d. It is noted that C2Cs 295a and 295b are different from one another only along the X-axis, but occurring only along the X-axis (as also depicted in C2Cs 291a and 291b of FIG. 11 above). C2Cs 295c and 295d are different from one another along both the X-axis and the Y-axis.

In some embodiments, in order to represent the trapezoid shape of structure 293, processor 20 is configured to apply a projective transformation (also referred to herein as a homography) to at least the regions of image 243 that are shown in FIG. 12.

Moreover, processor 20 is configured to apply the projective transformation for: (i) estimating the non-linear distortion in blanket 44, resulting in the different levels of C2C (along both X- and Y-axes) among C2Cs 295a-295d, (ii) correcting the C2Cs 295a-295d by “altering the location” of the magenta patterns along one or both of the X-axis and the Y-axis, to the location of the corresponding cyan patterns (e.g., “altering the location” of magenta pattern 292d, along the X- and Y-axes, to the location of cyan pattern 287a).

It is noted that in the example of FIG. 12, the projective transformation is applicable to produce the non-linear model of C2C occurring (e.g., due to the distortion of blanket 44) along one or both of the X- and Y-axes.

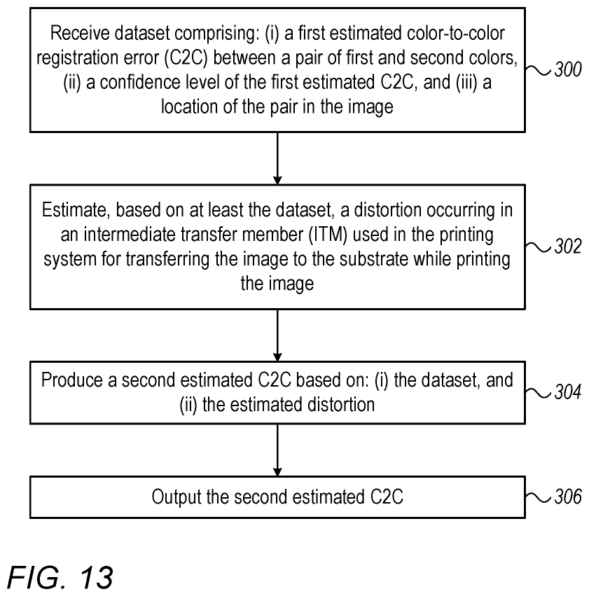

FIG. 13 is a flow chart that schematically illustrates a method for improving quality of C2C (e.g., estimated by the aforementioned NN) in image 243, in accordance with an embodiment of the present invention.

The method begins at a dataset receiving step 300, with interface 22 receiving the dataset from the NN. In the present example, the dataset comprises a first estimated C2C between one or more pairs of colors selected among the colors in image 243 (in the present example CMYK colors, but could be any other number of colors in other embodiments). In some embodiments, image 243 comprises multiple patches (e.g., regions 229-232) and the C2Cs are received for each patch and every pair of colors that passed the validity mask described in FIGS. 9 and 10A above.

In some embodiments, the dataset further comprises (i) a confidence level for each of the estimated C2Cs of the valid pairs, and (ii) a location of the pair in image 243, as described in detail in FIG. 9 above.

In some embodiments, interface is configured to receive an additional dataset comprising the additional estimated C2Cs for each of the CMYK colors, which is based on marks 224-227 of frames 221 and 221a, as described in detail in FIG. 9 above.

At a first estimation step 302, processor 20 is configured to estimate, based on (i) the dataset, and optionally, (ii) the additional dataset, a distortion occurring in blanket 44 of system 10, as described in detail in FIGS. 9-12 above. It is noted that blanket 44 is configured to receive an image (e.g., image 243) from image forming station 60, and to transfer image 243 to sheet 50, as described in FIG. 1 above. As such, any distortion in blanket 44 may affect (typically increase) the level of the C2C, as described in detail in FIG. 9 above.

At a second estimation step 304, processor 20 is configured to produce a second estimated C2C based on: (i) the dataset received from the NN, and (ii) the estimated distortion of step 302, as described in detail in FIG. 9 above.

It is noted that in step 304, processor 20 is configured to apply one or more weighting factors for improving the second estimated C2C. For example, processor 20 is configured to apply first and second weighting factors to the data received from (i) the NN-dataset, and (ii) the additional dataset, respectively, as described in detail in FIG. 9 above. Moreover, the values of the weighting factors depend, inter alia, on the sampling rate (e.g., region 259 and frame 221a), and the quality of C2C data (e.g., confidence level received from the NN) at different regions of image 243, as described in detail in FIG. 9 above.

At an output step 306 that concludes the method, processor 20 is configured to output the second estimated C2C to at least one of interface 22 and display 34, so that the user of system 10 could take any suitable corrective actions for reducing the level of C2C in image 243, as well as in other images printed by system 10.

Although the embodiments described herein mainly address detection and estimation of color-to-color registration errors (C2Cs) in digital printing using direct printing or using a flexible intermediate transfer member, the methods and systems described herein can also be used in other applications, such as in other sort of distortions occurring in a printed image, and/or in any sort of printing system and process having any suitable type of an intermediate member for receiving an image and transferring the image to a target substrate.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method for selecting a region of an image for training a neural network to detect a color registration error, the method comprising:
receiving first and second ink images of first and second ink colors, respectively, which are intended to be applied to a substrate for printing the image thereon;
producing a first gradient image based on the first ink image, and a second gradient image based on the second ink image; and
for at least a given region:
calculating a level of overlap between first and second structures appearing in the region in the first and second gradient images, respectively; and
selecting the given region for the training in response to finding that the level of overlap in the given region exceeds a predefined threshold.

2. The method according to claim 1, wherein the first and second ink images are in a first color space, and the first and second gradient images are in a second color space, different from the first color space.

3. The method according to claim 2, wherein producing the first and second gradient images comprises: (i) producing first and second images in the second color space by converting the first and second ink images, respectively, from the first color space to the second color space, and (ii) producing the first and second gradient images by applying one or more gradient filters to the first and second images, respectively.

4. The method according to claim 3, wherein the first color space comprises at least cyan, magenta, yellow and black (CMYK) colors, and the second color space comprises at least red, green and blue (RGB) colors, wherein the first ink image comprises a cyan ink image.

5. The method according to claim 4, wherein converting the first ink image comprises converting first gray levels (GLs) of the first ink image to second GLs of the RGB colors.

6. The method according to claim 3, wherein producing the first and second gradient images comprises: (i) applying the one or more gradient filters to the first image along a first direction and a second direction for producing a first pair of the first gradient image, and (ii) applying the one or more gradient filters to the second image along the first and second directions for producing a second pair of the second gradient image.

7. The method according to claim 3, wherein at least one of the gradient filters comprises a sobel filter.

8. The method according to claim 1, and comprising producing (i) a first binary image based on the first gradient image, and (ii) a second binary image based on the second gradient image, and wherein calculating the level of overlap comprises calculating the level of overlap between the first and second structures appearing in the region in the first and second binary images, respectively.

9. The method according to claim 8, wherein each of the first and second binary images comprises a predefined number of pixels, and wherein calculating the level of overlap comprises: (i) calculating a number of pixels that appear in both the first and second structures, and (ii) calculate the level of overlap by calculating a ratio between the calculated number of pixels and the predefined number of pixels.

10. The method according to claim 1, and comprising determining, based on the level of overlap, a quality index to the given region for the training.

11. A system for selecting a region of an image for training a neural network to detect a color registration error, the system comprising:
an interface, which is configured to receive first and second ink images of first and second ink colors, respectively, which are intended to be applied to a substrate for printing the image thereon; and
a processor, which is configured to:
produce a first gradient image based on the first ink image, and a second gradient image based on the second ink image; and
for at least a given region:
calculate a level of overlap between first and second structures appearing in the region in the first and second gradient images, respectively; and
select the given region for the training in response to finding that the level of overlap in the given region exceeds a predefined threshold.

12. The system according to claim 11, wherein the first and second ink images are in a first color space, and the first and second gradient images are in a second color space, different from the first color space.

13. The system according to claim 12, wherein the processor is configured to produce the first and second gradient images by: (i) producing first and second images in the second color space by converting the first and second ink images, respectively, from the first color space to the second color space, and (ii) producing the first and second gradient images by applying one or more gradient filters to the first and second images, respectively.

14. The system according to claim 13, wherein the first color space comprises at least cyan, magenta, yellow and black (CMYK) colors, and the second color space comprises at least red, green, and blue (RGB) colors, wherein the first ink image comprises a cyan ink image.

15. The system according to claim 14, wherein the processor is configured to convert the first ink image by converting first gray levels (GLs) of the first ink image to second GLs of the RGB colors.

16. The system according to claim 13, wherein the processor is configured to produce the first and second gradient images by: (i) applying the one or more gradient filters to the first image along a first direction and a second direction for producing a first pair of the first gradient image, and (ii) applying the one or more gradient filters to the second image along the first and second directions for producing a second pair of the second gradient image.

17. The system according to claim 13, wherein at least one of the gradient filters comprises a sobel filter.

18. The system according to claim 11, wherein the processor is configured to produce: (i) a first binary image based on the first gradient image, and (ii) a second binary image based on the second gradient image, and to calculate the level of overlap between the first and second structures appearing in the region in the first and second binary images, respectively.

19. The system according to claim 18, wherein each of the first and second binary images comprises a predefined number of pixels, and wherein the processor is configured to calculate the level of overlap by: (i) calculating a number of pixels that appear in both the first and second structures, and (ii) calculate the level of overlap by calculating a ratio between the calculated number of pixels and the predefined number of pixels.

20. The system according to claim 11, wherein the processor is configured to determine, based on the level of overlap, a quality index to the given region for the training.

21-44. (canceled)
